(19) United States
(12) Patent Application Publication
(10) Pub. No.: US 2023/0001310 A1
(43) Pub. Date: Jan. 5, 2023

(54) MINIATURE GO VARIANT WITH IMPROVED COMPUTER FUNCTIONALITY

(71) Applicant: Kyle Dennis Morris, Temecula, CA (US)

(72) Inventor: Kyle Dennis Morris, Temecula, CA (US)

(21) Appl. No.: 17/144,084

(22) Filed: Jan. 7, 2021

Related U.S. Application Data
(60) Provisional application No. 62/958,350, filed on Jan. 8, 2020.

(51) Int. Cl. A63F 13/822

(52) U.S. Cl. CPC A63F 13/822

(57) ABSTRACT

A method executes a two-player position competitive game of GO with an improved rate of play and reduction in required skill by players by:
a) providing a game board with a grid having between 4×4 and 6×6 squares for alternative placement of visually different stones in squares to score points;
b) placing stones for each of the two players;
c) each player allotted a specific number of additional stones for placement on the game board, with insufficient numbers of stone to fill the game board;
d) each player exhausting respective allotted stones;
e) after the two players have exhausted all respective allotted stones, determining a total absolute number value of how many stones have been captured by each player and how many spaces are controlled by each player's stones, with each player's total being compared either to the other player's total or against a paytable.

### RELATED APPLICATION DATA

This application claims priority from a pending U.S. Provisional Patent Application, U.S. Ser. No. 62/958,350, filed 8 Jan. 2020 by the inventor, and titled “MINIATURE GO VARIANT WITH IMPROVED COMPUTER FUNCTIONALITY.”

### BACKGROUND OF THE INVENTION

### 1. Field of the Invention

The present invention relates to of electronic game, electronic gaming, and apparatus and systems for enabling an improved process for executing the traditional game of GO.

### 2. Background of the Art

Go is usually played on a standard 19×19 grid, or board. There are usually nine marked points on the board. These points are usually referred to as the star points. They serve as reference points as well as markers on which the handicap stones are placed in handicap games.

The rules of GO are standard, even though it has been known to slightly vary the size of the boards to as few as 8×8 grids, with the game content remaining the same (e.g., https://www.britgo.org/intro/intro2.html). The basic of the game are basically that the game of Go starts with an empty board. Each player has an effectively unlimited supply of pieces (called stones), one taking the black stones, the other taking white. The main object of the game is to use your stones to form territories by surrounding vacant areas of the board. It is also possible to capture your opponent's stones by completely surrounding them.

Players take turns, placing one of their stones on a vacant point at each turn, with Black playing first. Note that stones are placed on the intersections of the lines rather than in the squares and once played stones are not moved. However, they may be captured, in which case they are removed from the board, and kept by the capturing player as prisoners.

The game is extraordinarily popular in some regions of the world. It is actually broadcast live in some countries, and even displayed on live billboards for the public to watch.

It is impossible to have a commercially viable casino (even a processor in an electronic gaming machine, known as an EGM) versus player gaming event because of the length of time needed in play and the fact that skill can be too favorable to one side versus the other. Even reducing the grid to the smallest typical grid of 8×8 squares does not speed up the game and allow sufficient numbers of games/minute to enable both a profit for the casino and reasonable chance of players winning over a reasonable period of time, such as in ten (10) games.

The present technology provides a system of executing competitive games of GO, especially in a gaming environment, by using software that enhances and improves execution of game play in both offering a lower degree of skill requirement for players to still win individual game outcomes and yet maintain a reasonable profit margin for the casino or on-line administrator with on-line gaming.

### SUMMARY OF THE INVENTION

A method executes a two-player position competitive game of GO with an improved rate of play and reduction in required skill by players by:
a) providing a game board with a grid having between 4×4 and 6×6 squares for alternative placement of visually different stones in squares to score points;
b) placing stones for each of the two players, with at least three stones being placed by random placement or from a template for each player;
c) each player being allotted a specific number of additional stones for alternative placement in open squares on the game board, but with insufficient numbers of stones to fill the game board;
d) each player exhausting respective allotted stones;
e) after the two players have exhausted all respective allotted stones, determining a total absolute number value of how many stones have been captured by each player and how many spaces are controlled by each player's stones, with each player's total being compared either to the other player's total or against a paytable to determine a winning or losing outcome for the board game.

### BRIEF DESCRIPTION OF THE INVENTION

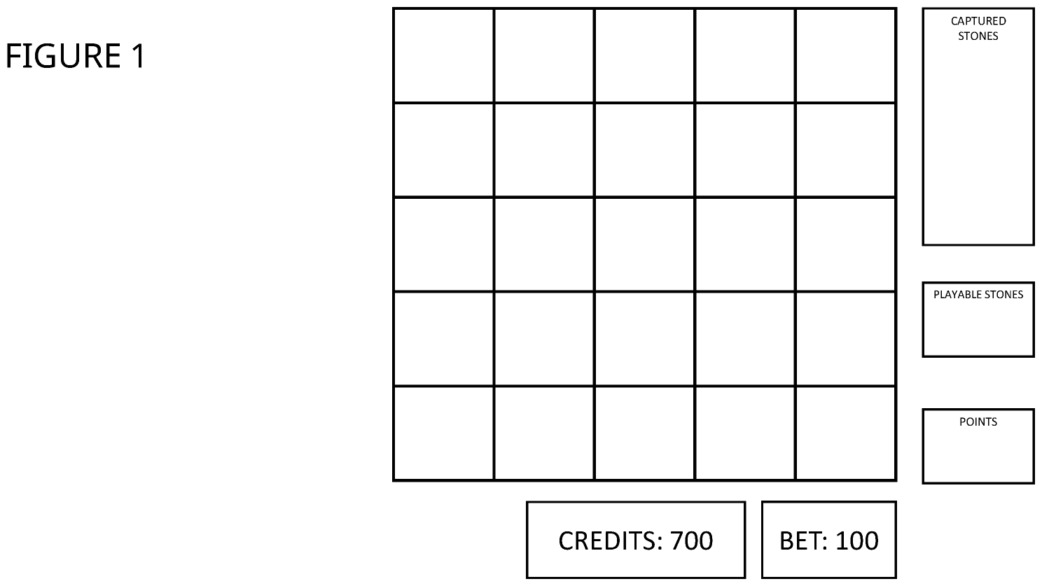

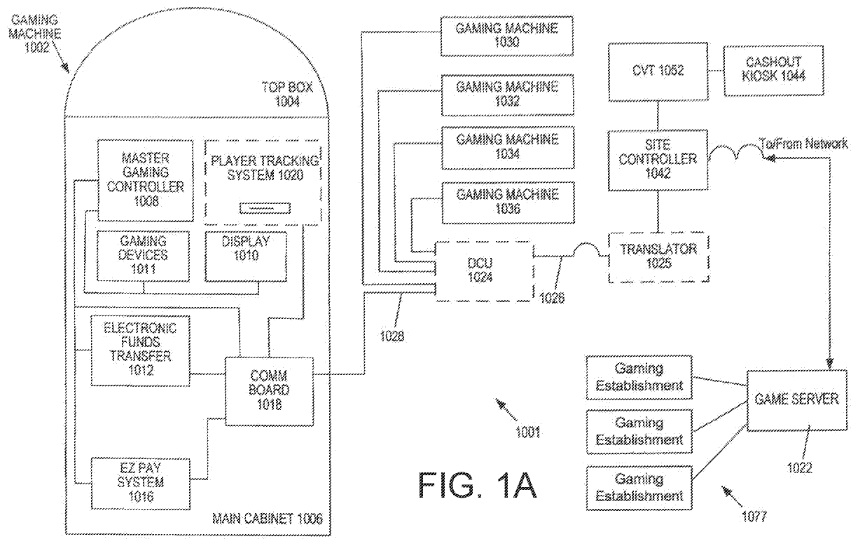

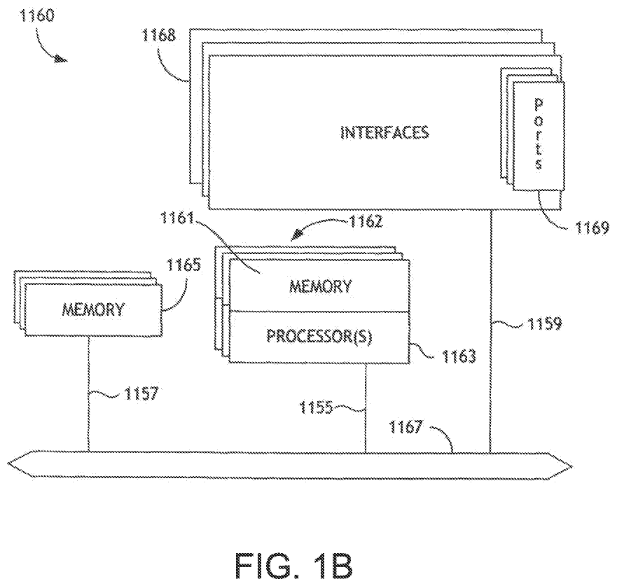

FIG. 1 shows an empty grid for executing a game of GO according to one embodiment of the present invention

FIG. 1A shows a schematic for an electronic system for enabling play of the gaming method described herein.

FIG. 1B shows another schematic for an electronic system for enabling play of the gaming method described herein.

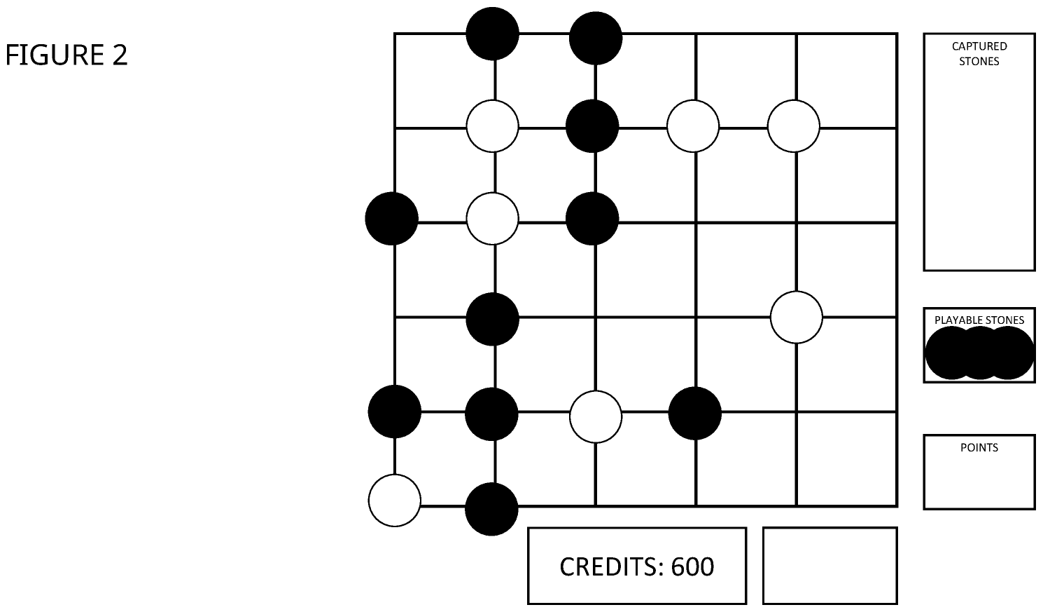

FIG. 2 shows a first step in the progression of a game of GO according to one aspect of the present invention.

FIG. 2A an exemplifying view of a remote site room according to one embodiment.

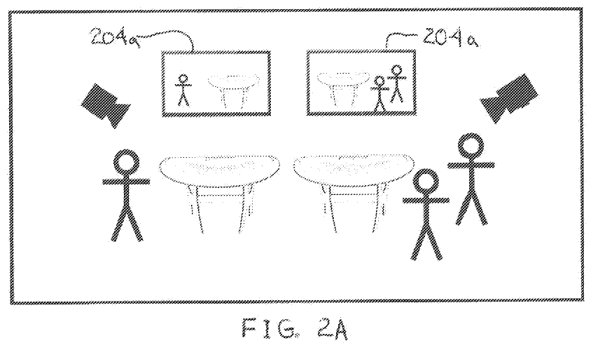

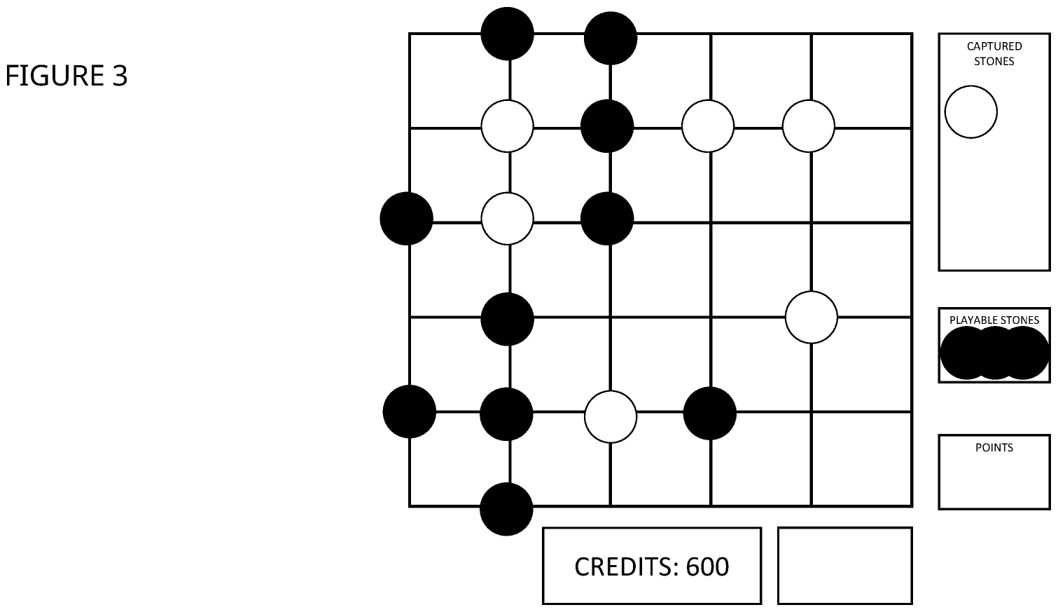

FIG. 3 shows a second step in the progression of a game of GO according to one aspect of the present invention.

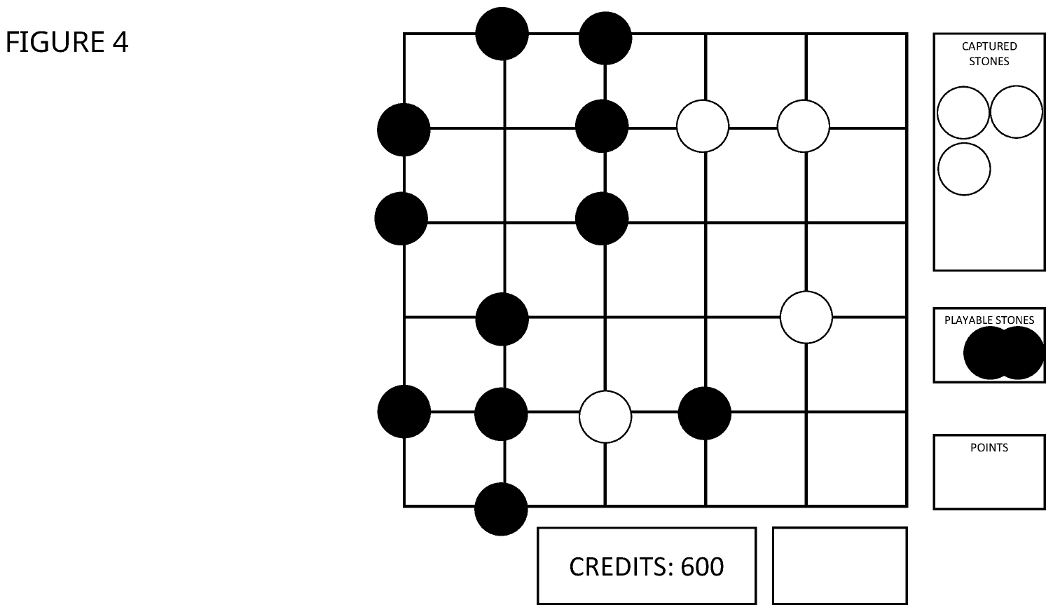

FIG. 4 shows a third step in the progression of a game of GO according to one aspect of the present invention.

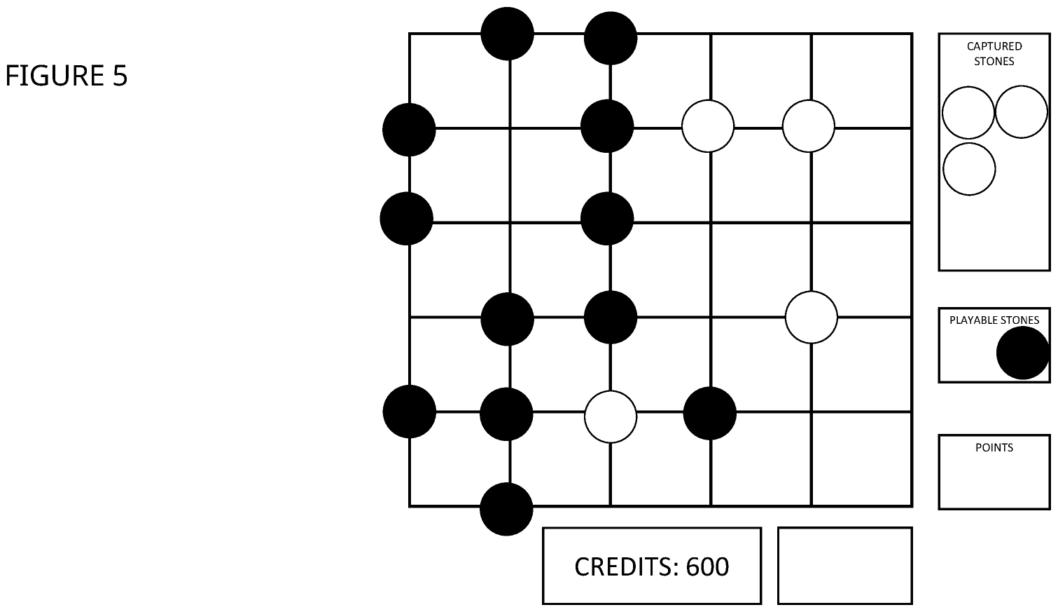

FIG. 5 shows a fourth step in the progression of a game of GO according to one aspect of the present invention.

FIG. 5A shows an embodiment of the invention using cloud storage.

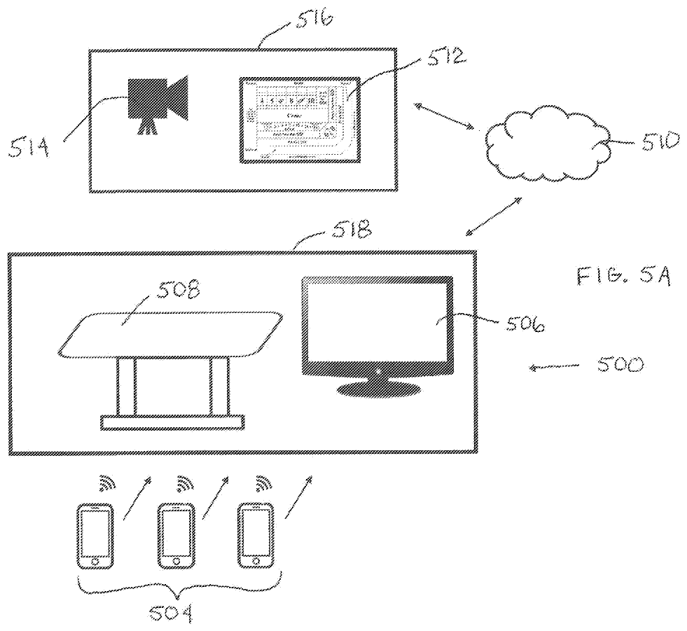

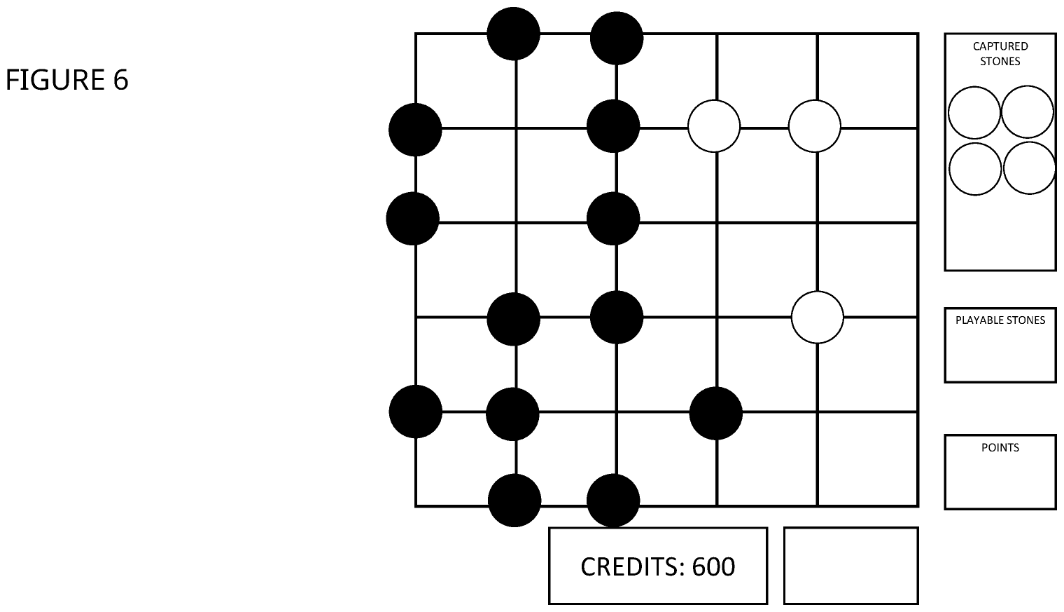

FIG. 6 shows a fifth step in the progression of a game of GO according to one aspect of the present invention.

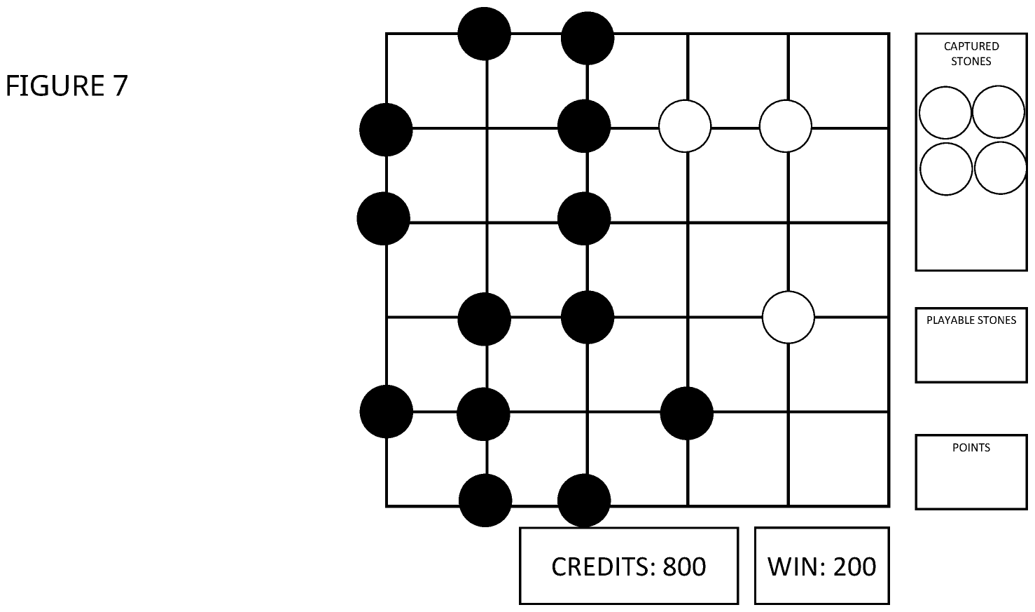

FIG. 7 shows a concluding step and resolution of a GO wagering event on an EGM according to one embodiment of the present invention.

### DETAILED DESCRIPTION OF THE INVENTION

A method executes an electronic two-player position competitive game of GO with improved rate of play and reduction in required skill by players by:
a) providing a game board with a grid having between 4×4 and 6×6 squares for alternative placement of visually different stones in squares to capture an opposing player's stones or to control enclosed squares;
b) placing stones for each of the two players, with at least three stones (preferably 4-10 stones) being placed by random placement (of an approximately equal number of stones for each player, such as ±1 or ±2 stones for the “house” player) or from a template for each player, with no player beginning the method with two or more stones than another player;
c) each player being allotted a specific number of additional stones for alternative placement in open squares on the game board, but with insufficient numbers of stones to fill the game board;
d) each player exhausting their respective allotted stones;
e) after the two players have exhausted all respective allotted stones, determining a total absolute number value of how many stones have been captured by each player and how many spaces are controlled by each player's stones, with each player's total being compared either to the other player's total or against a paytable to determine a winning or losing outcome for the board game.

As is known in GO, “control” of a space is determined by a fact that a continuous line of a single player's stones defines an enclosed area where the opponent or other player cannot insert a stone. For example, where a player forms a rectangle enclosing spaces adjacent a side of the grid structure, the enclosed number of squares are controlled and score points.

In the method, the game of GO may be executed on an electronic gaming machine including a processor, a video display with a touchscreen, in communication with the processor a value-in-value-out system selected from the group consisting of a currency receiver having a motor drive and a reader, a ticket-in-ticket out acceptor/printer having a motor drive to receive printed tickets and deliver tickets printed in the electronic gaming machine, and a near-field communication sensor, the processor in communication with the video display to display credits available for wagering and amount of credits wagered and/or won at the conclusion of each board game displayed as a virtual board game. The game may be electronically played on an electronic gaming machine, an electronic gaming table or on-line with a game manager. In the method, the grid may be a virtual grid of from 4×4 to 6×6 squares (with or without handicap dots shown, as known in the GO art), displayed on the display screen, and the processor provides a random combination of the two-player's stones as virtual stones on the video screen and assigns a fixed number of allotted stones to a first player at a player controls and to the processor as a virtual player in competition with the player at the player controls, the player at the player controls placing one virtual stone at a time by contacting the touchscreen on open squares to place, and the processor placing virtual stones in open spaces on the virtual grid. When the processor is acting as the virtual player, that virtual player may be assigned from 0-4, 0-3, 1-3 -r 2-3 stones for placement in addition to the already placed stones. The player at the player controls typically enters a wager from credit stored in a memory in the processor to initiate the game. The points attained by the player at the player controls are preferably compared against a paytable to determine a winning amount to be credited on the processor.

In an alternative method, the grid is a virtual grid of from 4×4 to 6×6 squares, displayed on the display screen, and the processor provides a template of a predetermined distribution of the two-player's stones as virtual stones on the video screen and assigns a fixed number of allotted stones to a first player at a player controls and to the processor as a virtual player in competition with the player at the player controls, the player at the player controls placing one virtual stone at a time by contacting the touchscreen on open squares to place, and the processor placing virtual stones in open spaces on the virtual grid.

The player at the player controls may enter a wager stored in a memory in the processor to initiate the game. The points attained by the player at the player controls are compared against a paytable to determine a winning amount to be credited on the processor.

There are at Least Three Ways in which the Board can be Populated:
Templates are used where the stones are pre-populated.
Random placement of both white and black stones on the board. (can be awkward)
Small patterns of stones populate the board with additional single stones filling in random spaces after the patterns have been placed. Think Tetris shaped pieces filling in the board first, then single stones falling into some of the empty spaces.

The use of templates seems to be the best method to protect the templates and the math could for all of the templates with zero, one, two and three additional stones. Since it is still desirable to have these boards and allowing players to make stone placements, the format will then still make sense to GO players, It may be the best way to capture the stones to take sections of the board from real GO games played in the internet. Depending on how many templates are needed to be captured for template use, it might be best to write a computer program to screen, capture and create our 100,000-1,000,000 boards.

### Scoring:

Scoring will consist of counting the number of stones in the player's color and multiplying their stone count by the number of stones they captured.

Optional: In traditional GO play, space that is cordoned off by stones of one color is counted as controlled by that player (because when playing with unlimited stones, that player would eventually capture that space). Since Mini GO is played with limited stones one option was to NOT allow players to score by blocking off areas, but it might be so ingrained in players' concept of the game of GO that the design of the gaming event may have to allow it for the players to accept the game. This is therefore an option included in scoring in the gaming event.

FIG. 1—Mini go is a faster, single player version of the traditional game of GO. The goal of the game is to control as much real estate on the board and to capture as many of the opposite colored stones as possible from a random or pre-determined array of white and black stones on a grid. To begin the game, the player makes a bet. (It is optional for the player to choose which color to play, white or black, before the board is revealed).

FIG. 1A shows a schematic for an electronic system for enabling play of the gaming method described herein.

FIG. 1B shows another schematic for an electronic system for enabling play of the gaming method described herein.

FIG. 2—Once the wager is made, a random or predetermined distribution of black and white stones is placed in the grid. The grid may range in size from 3×3 to the traditional 19×19. In this example, the player's color is black and the processor's (casino's) color is White.

FIG. 3—After the placement of the black and white stones, any stones that are automatically captured by the opposite color are removed. A stone or group of stones are captured when they are surrounded by stones of the opposite color and have no liberties (free intersections adjacent to them.) In this example, black automatically captures one white stone in the bottom left corner.

FIG. 4—The player may now place their stones on the grid to try to capture more of the opposite color stones. In this example, the player moves the first stone into the open space near the top left of the grid to capture two additional white stones. (In the alternate versions, players may have to make a choice between capturing stones or controlling more of the board.)

FIG. 5—The player placed the next stone to partially block a white stone.

FIG. 6—The player places the final black stone to capture one additional white stone.

FIG. 7—After the player's final stone is placed, the game tabulates a score based on the winning parameters of the game.

In this example, each captured stone of the opposite color is worth 50 credits for a total win of 200 credits.

Another gaming network that may be used to implement some aspects of the invention is depicted in FIG. 1A. Gaming establishment 1001 could be any sort of gaming establishment, such as a casino, a card room, an airport, a store, etc. In this example, gaming network 1077 includes more than one gaming establishment, all of which are networked to game server 1022.

Here, gaming machine 1002, and the other gaming machines 1030, 1032, 1034, and 1036, include a main cabinet 1006 and a top box 1004. The main cabinet 1006 houses the main gaming elements and can also house peripheral systems, such as those that utilize dedicated gaming networks. The top box 1004 may also be used to house these peripheral systems.

The master gaming controller 1008 controls the game play on the gaming machine 1002 according to instructions and/or game data from game server 1022 or stored within gaming machine 1002 and receives or sends data to various input/output devices 1011 on the gaming machine 1002. In one embodiment, master gaming controller 1008 includes processor(s) and other apparatus of the gaming machines described above. The master gaming controller 1008 may also communicate with a display 1010.

A particular gaming entity may desire to provide network gaming services that provide some operational advantage. Thus, dedicated networks may connect gaming machines to host servers that track the performance of gaming machines under the control of the entity, such as for accounting management, electronic fund transfers (EFTs), cashless ticketing, such as EZPay™ marketing management, and data tracking, such as player tracking. Therefore, master gaming controller 1008 may also communicate with EFT system 1012, EZPay™ system, and player tracking system 1020. The systems of the gaming machine 1002 communicate the data onto the network 1022 via a communication board 1018.

It will be appreciated by those of skill in the art that embodiments of the present invention could be implemented on a network with more or fewer elements than are depicted in FIG. 1A. For example, player tracking system 1020 is not a necessary feature of some implementations of the present invention. However, player tracking programs may help to sustain a game player's interest in additional game play during a visit to a gaming establishment and may entice a player to visit a gaming establishment to partake in various gaming activities. Player tracking programs provide rewards to players that typically correspond to the player's level of patronage (e.g., to the player's playing frequency and/or total amount of game plays at a given casino). Player tracking rewards may be free meals, free lodging and/or free entertainment. Player tracking information may be combined with other information that is now readily obtainable by an SBG system.

Moreover, DCU 1024 and translator 1025 are not required for all gaming establishments 1001. However, due to the sensitive nature of much of the information on a gaming network (e.g., electronic fund transfers and player tracking data) the manufacturer of a host system usually employs a particular networking language having proprietary protocols. For instance, 10-20 different companies produce player tracking host systems where each host system may use different protocols. These proprietary protocols are usually considered highly confidential and not released publicly.

Further, gaming machines are made by many different manufacturers. The communication protocols on the gaming machine are typically hard-wired into the gaming machine and each gaming machine manufacturer may utilize a different proprietary communication protocol. A gaming machine manufacturer may also produce host systems, in which case their gaming machines are compatible with their own host systems. However, in a heterogeneous gaming environment, gaming machines from different manufacturers, each with its own communication protocol, may be connected to host systems from other manufacturers, each with another communication protocol. Therefore, communication compatibility issues regarding the protocols used by the gaming machines in the system and protocols used by the host systems must be considered.

A network device that links a gaming establishment with another gaming establishment and/or a central system will sometimes be referred to herein as a “site controller.” Here, site controller 1042 provides this function for gaming establishment 1001. Site controller 1042 is connected to a central system and/or other gaming establishments via one or more networks, which may be public or private networks. Among other things, site controller 1042 communicates with game server 1022 to obtain game data, such as ball drop data, bingo card data, etc.

In the present illustration, gaming machines 1002, 1030, 1032, 1034 and 1036 are connected to a dedicated gaming network 1022. In general, the DCU 1024 functions as an intermediary between the different gaming machines on the network 1022 and the site controller 1042. In general, the DCU 1024 receives data transmitted from the gaming machines and sends the data to the site controller 1042 over a transmission path 1026. In some instances, when the hardware interface used by the gaming machine is not compatible with site controller 1042, a translator 1025 may be used to convert serial data from the DCU 1024 to a format accepted by site controller 1042. The translator may provide this conversion service to a plurality of DCUs.

Further, in some dedicated gaming networks, the DCU 1024 can receive data transmitted from site controller 1042 for communication to the gaming machines on the gaming network. The received data may be, for example, communicated synchronously to the gaming machines on the gaming network.

Here, CVT 1052 provides cashless and cashout gaming services to the gaming machines in gaming establishment 1001. Broadly speaking, CVT 1052 authorizes and validates cashless gaming machine instruments (also referred to herein as “tickets” or “vouchers”), including but not limited to tickets for causing a gaming machine to display a game result and cash-out tickets. Moreover, CVT 1052 authorizes the exchange of a cashout ticket for cash. These processes will be described in detail below. In one example, when a player attempts to redeem a cash-out ticket for cash at cashout kiosk 1044, cash out kiosk 1044 reads validation data from the cashout ticket and transmits the validation data to CVT 1052 for validation. The tickets may be printed by gaming machines, by cashout kiosk 1044, by a stand-alone printer, by CVT 1052, etc. Some gaming establishments will not have a cashout kiosk 1044. Instead, a cashout ticket could be redeemed for cash by a cashier (e.g. of a convenience store), by a gaming machine or by a specially configured CVT.

FIG. 1B illustrates an example of a network device that may be configured for implementing some methods of the present invention. Network device 1160 includes a master central processing unit (CPU) 1162, interfaces 1168, and a bus 1167 (e.g., a PCI bus). Generally, interfaces 1168 include ports 1169 appropriate for communication with the appropriate media. In some embodiments, one or more of interfaces 1168 includes at least one independent processor and, in some instances, volatile RAM. The independent processors may be, for example, ASICs or any other appropriate processors. According to some such embodiments, these independent processors perform at least some of the functions of the logic described herein. In some embodiments, one or more of interfaces 1168 control such communications-intensive tasks as encryption, decryption, compression, decompression, packetization, media control and management. By providing separate processors for the communications-intensive tasks, interfaces 1168 allow the master microprocessor 1162 efficiently to perform other functions such as routing computations, network diagnostics, security functions, etc.

The interfaces 1168 are typically provided as interface cards (sometimes referred to as “linecards”). Generally, interfaces 1168 control the sending and receiving of data packets over the network and sometimes support other peripherals used with the network device 1160. Among the interfaces that may be provided are FC interfaces, Ethernet interfaces, frame relay interfaces, cable interfaces, DSL interfaces, token ring interfaces, and the like. In addition, various very high-speed interfaces may be provided, such as fast Ethernet interfaces, Gigabit Ethernet interfaces, ATM interfaces, HSSI interfaces, POS interfaces, FDDI interfaces, ASI interfaces, DHEI interfaces and the like.

When acting under the control of appropriate software or firmware, in some implementations of the invention CPU 1162 may be responsible for implementing specific functions associated with the functions of a desired network device. According to some embodiments, CPU 1162 accomplishes all these functions under the control of software including an operating system and any appropriate applications software.

CPU 1162 may include one or more processors 1163 such as a processor from the Motorola family of microprocessors or the MIPS family of microprocessors. In an alternative embodiment, processor 1163 is specially designed hardware for controlling the operations of network device 1160. In a specific embodiment, a memory 1161 (such as non-volatile RAM and/or ROM) also forms part of CPU 1162. However, there are many different ways in which memory could be coupled to the system. Memory block 1161 may be used for a variety of purposes such as, for example, caching and/or storing data, programming instructions, etc.

Regardless of network device's configuration, it may employ one or more memories or memory modules (such as, for example, memory block 1165) configured to store data, program instructions for the general-purpose network operations and/or other information relating to the functionality of the techniques described herein. The program instructions may control the operation of an operating system and/or one or more applications, for example.

Because such information and program instructions may be employed to implement the systems/methods described herein, the present invention relates to machine-readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media; and hardware devices that are specially configured to store and perform program instructions, such as read-only memory devices (ROM) and random access memory (RAM). The invention may also be embodied in a carrier wave traveling over an appropriate medium such as airwaves, optical lines, electric lines, etc. Examples of program instructions include both machine code, such as produced by a compiler, and files containing higher-level code that may be executed by the computer using an interpreter.

Although the system shown in FIG. 1B illustrates one specific network device of the present invention, it is by no means the only network device architecture on which the present invention can be implemented. For example, an architecture having a single processor that handles communications as well as routing computations, etc. is often used. Further, other types of interfaces and media could also be used with the network device. The communication path between interfaces may be bus based (as shown in FIG. 1B) or switch fabric based (such as a cross-bar).

The term digital wallet is a blanket descriptor for a range of technologies that let you perform many tasks. In general, though, a digital wallet (also sometimes called an e-wallet) is a transformation in the way individuals pay for things.

Many digital wallet services work through apps on smartphones. At the supermarket, for instance, the phone is simply tapped to a compatible check-out register to pay instantly. For others, all you need to enter is a mobile phone number and a PIN (personal identification number).

No matter what form it takes, a digital wallet is based on encryption software that substitutes for old software, analog wallet during monetary transactions. There are benefits in the protection and convenience. Merchants benefit because they're more protected against fraud and they sell more products, faster.

A smartphone digital wallet will help pay for anything, but it will also store concert tickets, bus and subway passes, gift cards and in the present technology, credit stored, transferred or received from an electronic gaming machine. Casinos will reward loyalty by offering instant freebies, discounts and coupons.

Digital wallets can be broken into two broad categories: client-side and server-side. Within both categories are wallets that function only with specific vendors (either online or offline) and others that will work with just about any merchant.

Client-side wallets generally refer to those maintained by the customer, the end user. They download and install a program and then enter all of pertinent payment and shipping information, all of which is stored on a personal computer. Then, when it is decided to check out at a compatible Web site, the wallet's software completes most of the basic information so the customer doesn't have to. Suddenly, gaming gets faster and advantageous to the casino. A mobile digital wallet—that is, one on a smartphone—could transform the way customers pay no matter where they are in the casino.

More than half of Americans now own smartphones, and experts say that number will only continue to rise and more of those phones are equipped with an NFC (near-field communication) chip, which is a vital component to the mobile digital wallet infrastructure. It was estimated that around half of smartphones could have NFC by 2015. NFC technology may be seen everywhere very soon.

In marketing to consumers, two hot-button words always appear: security and privacy. It's easy for people to imagine all of the ways criminals or even casinos could abuse digital wallets. Those could hack into the account, exhaust the account and run up credit card balances, or maybe steal an identity.

Concerns are heightened when laypeople are considering the complexity of a digital-wallet transaction, especially compared to the simplicity of cash or straight credit. In the case of a smartphone, data passes through not only the smartphone's hardware and operating system but then also through a specific payment app, and finally the source of the payment, such as a bank or PayPal account. Casinos will be falling all over themselves to get player digital wallet business. Household names such as Google, Visa, MasterCard, Verizon, Apple, AT&T, PayPal and Square will be vying for players' attention.

All of these organizations will position themselves for the upper hand, in part by creating alliances with other corporate players in the gaming industry. PayPal started with Home Depot. Square teamed up with Starbucks. Google Wallet first matched with MasterCard. Ifs all part of the plan to slowly build their way into the casinos' normal operation. They know that if they can convince players and casinos to use their form of wallet first, players and casinos be unlikely to switch for an extended period a time.

Eventually, digital will complete its takeover and it is likely most wagering (with the exception of craps and roulette) will be using virtual money. Whether that's a good thing remains to be seen. In the meantime, players fumble with cash, tickets, coins and paper transactions with cashiers, all of which are remnants of a pre-digital economy and are primitive (and sometimes aggravating) simply by the nature of their design. Digital, of course, will have its own set of frustrations, and until they are confronted, the industry will not be assured they are worth the trouble of giving up cash.

A Google Wallet is inherently no different from any other money wallet. The basics behind all the wallets are the same. Each wallet is a bank account in some banking system. The entire eco system of wallet users, are simply a singular branch. If the name “PayPal” is changed, it depicts very well how a digital money wallet works. Among technical disclosures of electronic payment systems are US Patent Application. Published Documents No, 2013/0344161; 2014/0214654; 2006/0059038; and 2003/0034378; and U.S. Pat. No. 6,726,100.

In general terms as shown in FIG. 5A, a system 500 for the real time attendance, from a remote game site 516, at a game going on at relocated game site 518, comprises means 506, 514 for the audio and video reproduction of recordings of the relocated game site 518, at said remote game site 516, and means 508 for virtually repeating, in said remote game site 516, a game surface 505 existing in said relocated game site 518. A screen 506 displays game content captured at a craps game table 512 and stored and transmitted through the cloud 510. Individual players may enter wagers through personal data devices 504 (e.g., smartphones, pad, notebook, PCs, or dedicated wagering devices). Furthermore, the system may include one or more interface devices or programmable devices 504 apt to allow an interaction between a gamer and said game surface 512 existing in said relocated game site 516. To make clear the modes to promote the real time remote game, the complete cycle which is performed by the gamer in this context is described hereinafter. The cycle starts when a gamer enters the room of the remote site 518 (shown in FIG. 2A) and, after acquiring the information reported inside the room and after viewing the live game session, coming from the relocated site 516, projected on one or more monitors/tv sets 204a of the room itself, wishes to attend the game. Each programmable electronic device comprises 504 a display, and it is configured for reproducing on said display information related to the game surface 512 existing in the relocated game site 516.

Furthermore, advantageously, the programmable electronic device is programmed so as to allow the gamer to attend the game from said remote site 518. For example, by exploiting current smartphones (pads or tablets or the like), the gamer is allowed, following registration on a web platform, to download an Application for accessing the game on his/her own smartphone or tablet (hereinafter such Application will be referred to with the short-term App).

At this point, the gamer may load the funds he/she wishes on his/her own game account and he/she is ready to attend the available games. As previously mentioned, the means 504 for the audio and video reproduction comprises one or more cameras 514 arranged at the relocated game site 518 and/or one or more monitors/tv sets arranged at the remote game site 518. In this way, to improve the game experience of the gamer, the live broadcast of the game session really performed by a croupier operating at the relocated side 518, is made available on a big monitor/tv set, which the gamer may attend through his/her own game App available on his/her own mobile device (smartphone or tablet or the like). For example, in case of the roulette game, the gamer has available on his/her own mobile device an App reproducing chips and game table, therethrough he/she may perform bets by touching the table area of interest. Data may be fed or stored in the cloud 8a.

FIG. 2B shows, schematically, the main components of a remote game site 200 according to one embodiment. In particular, a cash station 240a is shown, which will be handled by an operator of the game site 200 a, usable for example by the gamers for the preliminary procedures of loading funds onto their own game account. The cash station 240a provides a personal computer 216a, thereto a scanner 214a and a printer 212a are advantageously connected for the administrative type requirements (registration of gamers, scanning of identity documents, etc.). The cash station 240a could further be equipped with a router 204a (preferably of wireless type) for accessing a local network. Furthermore, in order to improve the game experience of the gamer and to promote the socialization with other people present in the room, inside the same there are means for virtually repeating the game surface 512 of FIG. 5A. Said means comprises a game table 512, also shown in FIG. 2B.

The game table 5 is equipped with apparatuses for implementing the function thereof of repeating the game surface 512. In particular, the game table surface 512 comprises a horizontal, preferably high-definition monitor, whereon an image is reproduced, shown by way of example in FIG. 5A, updated in real time, of the game surface 512, existing in the relocated game site 518, and a QR-Code of the room identifying the table, shown by way of example in FIG. 4A.

Each bet performed by the gamer through his/her own App is repeated even onto the horizontal monitor, which reproduces the game layout of the craps table or roulette table itself (FIG. 5A). Said horizontal monitor has no interactive feature, but it reproduces exclusively what made individually by each gamer on his/her own mobile device.

Furthermore, as it is still visible in FIG. 2B, the game table surface 512 in turn comprises apparatuses to be connected, preferably in wireless mode, to the local network and, by means of internet, to the relocated game site. To this purpose, a processor 216a may be provided, thereto an access point 202a, for the connection to Internet, and a router 204a, for the connection to the local network, are connected, for example by means of a switch 203a. Furthermore, an additional monitor 300, arranged in the room of the remote game site 516, may be connected to the processor 209a, in case by means of an additional personal computer 201a, for enjoying a live broadcast by the gamers and/or other present people. Other multimedia devices, such as for example loudspeaker baffles 302, may be connected to the monitor. Advantageously, by means of the cash PC 216, positioned in the cash station, the operator is capable to handle the devices constituting the system. For example, he/she could turn off and/or re-start the table, turn-off or re-start the PC for the live broadcast, change the camera for displaying the live broadcast from the casino. The game table 5a inside the room has a shape very similar to that of a real casino-like table (508 FIG. 5A). The table is capable of improving the game experience of the gamer by favoring the socialization thereof with other people present in the room, by allowing the following procedures: i) receiving the gamers and the devices and drinks thereof; ii) reproducing the QR-Code of the room identifying the table; iii) reproducing the layout for the performed casino-like game bets; iv) reproducing the winning number (or the hand) and of the game statistics; v) reproducing the bets performed by the gamers present in the room.

Furthermore, it is equipped with stools to make the gamers to sit down around the periphery thereof, by offering the latter the possibility of positioning their own drinks in suitable housing and resting easily their own smartphones or tablets during the succession of the several game sessions.

At the end of the game, the gamer who wishes to withdraw the funds existing on his/her own game account may do it by using the technological infrastructures supporting the electronic money instruments existing in the room itself

### Phase for Registering on the Web Platform

The mechanism provided for registering the gamer onto the web platform, according to one embodiment, is the following;

The not registered gamer goes to a registration point (or cash station), wherein it provides to an operator his/her own identity card, fiscal code, mobile phone number and e-mail address.

The operator positions the documents under an OCR and the recording software acquires the included data and uses them to compile, automatically, a customer registration form, apart from the possibility of inserting possible missing data, such as for example e-mail address, by an operator in manual mode.

Furthermore, the software, still automatically, generates a username (obtained by means a code for processing the customer data) and a password, not visible by the operator himself/herself.

In this phase, the operator's software interacts with that of the Web platform to verify the correctness and uniqueness of the entered data. In particular, username and password are checked, which, if validated, are proposed to the customer printed on a receipt.

Once the data have been validated, the customer enters username and password—by copying them from the print received from the operator—onto the App to perform the first access. With such identifying credentials, the App downloads and proposes to the customer the corresponding game contract which may be accepted as in case of a software license.

After the contract acceptance, which is communicated to the system by electronic means, the gamer is registered on the game platform.

### Step of Downloading and Starting the App for Accessing the Game

As said previously, in order to access the on-line game platform, the gamer downloads an App on his/her own device, by following the instructions provided to him by the operator at a registration point, which will have also indicated how activating and configuring the room's Wi-Fi connection on his/her own device.

The game App is the App which the gamer has available on his/her own smartphone or tablet or the like (both of Android and iOS type) to attend the on-line game session inside the room. Substantially, the game App allows the following procedures:
associating the user to the room game table by scanning a QR-Code;
selecting the color of the chips therewith the bets performed by the user will be reproduced onto the game table;
accessing the game;
detecting and sending the bets performed by the user to the game table.
   Once downloaded and started the App for accessing the game, this shows a screen allowing the user to decide if he/she wants to play in a room arranged to house the game system, together with other users, or to play on his/her own (for example staying at home). In the first case (“Accessing the game with QR Code”), the user accesses the screen for scanning the room QR-Code, whereas, in the second case (“Accessing directly the game”), the user is redirected directly to the login screen.

To play in the room, a picture of the QR-Code reproduced onto the horizontal screen 5 of the table existing in the room itself is acquired.

When the user selects the item “Accessing the game with QR-Code”, the App searches for and connects automatically to the dedicated Wi-Fi network, thus allowing to detect the user in the specific game room and, still, to associate the user to the specific game table.

However, the use of proximity mechanisms alternative to the QR-Code, such as the detection of the room's Wi-Fi network, Bluetooth, or ultrasounds may be provided.

After having acquired the QR-Code, at first a screen is open for selecting the color therewith the chips will be reproduced onto the game table and then directly the screen is open for inserting the credentials. Once inserted such credentials, the customer may even tick off the option for storing the same, so that for future accesses it is no more necessary to re-enter them.

The first time it performs the login, the game App shows to the customer the game contract which may be accepted simply by pressing on a suitable button.

On the contrary, the subsequent times the user could perform the access by simply pressing the login button without having the contract to be re-proposed or having to enter again his/her own credentials, if the previous time he/she has ticked off the option for storing the same.

After acquiring the QR-Code and inserting the credentials (username and password), the game App goes in background, it launches automatically the browser to the address including the game application and it maps all bets performed by the customer on the game interface. From this moment on, in fact, all actions performed by the user on such interface (bets included) are intercepted by the app in background and sent instantaneously to the game table by allowing the reproduction thereof on it.

Thanks to the rapidity therewith information is intercepted and transmitted by the App to the table (less than 0.2 sec), and the similarity between interface on the table and on the App allowing to perform the game, the gamer has the feeling to “put down” the game chip onto the table by using his/her own smartphone or tablet or the like.

### Step of Loading the Game Account

The loading of the game account takes place according to the following mechanism, according to one embodiment, shown schematically in FIG. 3.

The customer refills cash funds on his/her own card at the room operator and moves the wished funds from his/her own card onto the licensee's one by using the dedicated App, allowing him/her to define the amount to be moved.

The licensee receives a notification of occurred crediting of the customer funds, therethrough it is possible automatically to proceed with reloading the game account of the latter.

In the game App a user menu is integrated allowing to access quickly the information of the game account, to withdraw other funds from the account and to bring them onto the game, to access information of the responsible game and to perform the logout.

### Step of Detecting the Customer Near the Room/Table

The detection of the gamers in the room takes place in the following way:
The gamer, by means of the App for accessing the game, takes a picture of the QR-Code reproduced automatically onto the horizontal monitor existing onto the room table. The App sends to the table the username of the gamer, which thus results to be detected in that specific room.

As already said, the use of proximity mechanisms alternative to the QR-Code may however be provided, such as the detection of the room Wi-Fi network, Bluetooth, or ultrasound. The live broadcasting of the game sessions is made available in order to improve the game experience of the gamer by allowing:
the display of the live broadcasting of the game sessions from the relocated site;
the diffusion of casino sounds associated to the live broadcast (sound of the small ball in the roulette cylinder, sound of the playing cards, croupier voice).

On the contrary, onto the horizontal monitor space is left to the display of chips and the layout for the bets.

By means of the control panel made available for the operator in the cash station, in the room one could decide if adding to the live display a “blinking” animation for the last released numbers existing in the panel of statistics. Furthermore, the room operator could decide if he/she wants to display the statistics next to the live video, to display the live broadcast from the casino only or to display the statistics only.

It should be recalled that the game play takes place exclusively through the dedicated App on smartphone or tablet or the like. The table present in the room may be used only to implement a visual effect. In particular, the gamer starts the game App installed on his/her own smartphone or tablet or the like, he/she takes a picture of the QR-Code and selects the color of the chips therewith his/her own bets will be reproduced onto the game table 5. The user may choose a determined color among the available ones, or decide if making him/her to be assigned one in a casual way. In the first case, the user is sent directly to the game application, whereas in the second case (by selecting the function “Skip this passage”), the user is assigned a casual chip color, which he/she may decide to be confirmed or modified.

At this point, the App re-addresses the user automatically to the website managed by the licensee wherein, by entering his/her own credentials, he/she accesses the game application. The latter allows to perform all possible practiced on-line casino game bets and to display exclusively his/her own bets.

In practice, the gamer displays on the App game interface the game layout and all chips available for the bets and first of all, to perform a bet, he/she has to select the chip and then the selected bet option. The game interface on smartphone or tablet or the like reproduces exactly the layout of the running game and it is almost identical in shape and color to that on the monitor embedded in the table 5.
The reproduction of the bets performed on line by the gamers on the room table is possible thanks to a Web Service, dialoguing with a central system, in turn connected to the table software, to define:
the table status;
the winning outcome;
all game information relating usual gamers present in the room.

The game App provides to the game, via Wi-Fi, information on username of the gamers detected near the latter and those relating the bets performed by them. The game table communicates to the central system the username of the detected gamers, so as to receive, apart from the information related to the table status and the winning number, even that on the bets accepted only by the gamers really present in the room.

The table status shows when the game is open or closed, that is when the gamers' bets have to be, or do not have to be, reproduced onto the monitor/tv set. This avoids that the bet performed by a gamer, when the game is closed, is however displayed onto the table, notwithstanding it has not been accepted by the game platform. In the game table user messages were added to alert the customer of the imminent closing of the bets or the closing of the same.

At the end of the game session, the central system communicates to the table the winning outcome or hand starts flashing on the game table, together with all chips of the winning bets, whereas statistics are updated. At this point, all losing bets disappear from the table, wherein only the winning ones remain. When the central system communicates the start of a new game session to the table, the flashing of the extracted number stops and the winning bets disappear from the table.

Substantially, according to one embodiment, the mechanism for reproducing the bets is the following one. As soon as the gamer performs a bet onto the platform of the game App, the latter, by means of a communication system (for example of Wi-Fi type), transmits it to the game table, whereon it is reproduced exactly, so that all gamers present in the room and those attending the same game session may view it.

If a gamer is no longer connected to the Wi-Fi of the VLT room, he/she could no longer interact with the game table and the bets he/she performs will no longer be reproduced thereon.

The bets of the several gamers are reproduced onto the game table with chips with different colors, depending upon the color selected by each one of them on the App. In this way, the chips of each gamer on the game table corresponds a unique color and each one is able to distinguish their bets from those performed by the other ones. The game table reproduces immediately the bet performed in a temporary flashing state. When the table has received the message of occurred bet acceptance, sent by the central system, the reproduced chips will cease to flash, to show that the bet has been accepted and it results to be valid. On the contrary, if within a certain period of time the table does not receive the message of occurred bet acceptance, the reproduced chips disappear, to show that the bet has not been accepted.

Mode for Withdrawing Funds from the Game Account

To give the gamer the possibility of withdrawing the funds present on his/her own game account, the following procedure, according to one embodiment, is provided. The customer who wants to withdraw the funds from his/her own game account forwards the request thereof to the licensee by means of the dedicated App, which allows him/her to define the amount to be withdrawn from the card of the licensee dedicated to the withdrawal, in order to deposit it onto his/her own reloadable card. The licensee receives a notification of the customer request and, once verified the presence of sufficient funds onto the game account of the latter, at first moves the requested funds from the game account to his/her own card, then from his/her own card to that of the customer.

In that moment the customer may go to the room operator and may withdraw cash funds from his/her own card.

The method may be executed on a gaming network including individual player terminals, an internet server connecting all player positions, and a game processor receiving player position player identification information, wherein the game processor receives player input on all player input and resolves all game events after determining an end of game event has occurred. The game processor may determine the end of game by determining that all player positions have attained a final point count total competitive in the game.

Still another method of executing a wagering event in a player versus player wagering event supported by a non-wagering third party using at least one standard virtual deck of playing cards on an electronic gaming table.

The gaming event may also be dealt live at a controlled (e.g., casino) location, broadcast as video to players on individual gaming platforms and devices (e.g., smart phones, pads, tablets, processors with screens and inputs and other devices), with players making wagers through credit or established accounts with the manager of the system.

In one embodiment, described in more detail below as a “chipless gaming platform”, the gaming device includes one or more display devices that are mounted into a gaming table surface and are controlled by the processor in addition to or separately from the individual player monitors. The display devices are preferably connected to or mounted into the table structure.

This may include a central display device which displays a primary game, dealer images, jackpot information, or information that is not specifically related to the game, such as sports information or winning events at other tables. This display device may also display any suitable secondary game associated with the primary game as well as information relating to the primary or secondary game (e.g., side bets, bonuses, jackpots and the like).

An alternative embodiment may include a central horizontal game display device and a vertically oriented virtual dealer display device as in Shuffle Master, Inc.'s Table Master™ gaming system. The central display device may display the primary game, any suitable secondary game associated or not associated with the primary game and/or information relating to the primary or secondary game. These display devices may also serve as digital glass operable to advertise games or other aspects of the gaming establishment. The gaming device includes a credit display 20 which displays a player's current number of credits, cash, account balance, or the equivalent. In one embodiment, the gaming device includes a bet display displays a player's amount wagered. In one embodiment, as described in more detail below, the gaming device includes a player tracking display which displays information regarding a player's play tracking status.

In yet another embodiment, at least one display device may be a mobile display device, such as a PDA or tablet PC that enables play of at least a portion of the primary or secondary game at a location remote from the gaming device. The display devices may include, without limitation, a monitor, a television display, a plasma display, a liquid crystal display (LCD) a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism.

In one embodiment, as described in more detail below, the display device includes a touch-screen with an associated touch-screen controller. The display devices may be of any suitable size and configuration, such as a square, a rectangle or an elongated rectangle. The display devices of the gaming device are configured to display at least one and preferably a plurality of game or other suitable images, symbols and indicia such as any visual representation or exhibition of the movement of objects such as mechanical, virtual, or video reels and wheels, dynamic lighting, video images, images of people, characters, places, things, faces of cards, images of dealers and the like.

Other forms of the invention are in the form of game software that is implemented in a variety of formats, such as internet gaming, PC practice play, hand-held game devices, wireless gaming devices and the like.

### Chipless Gaming Table Implementation

One enabling system useful in the practice of the present invention is the use of playing cards with Go board game layouts and symbols which can be distributed for use with a system marketed under the name i-TABLE™ by Shuffle Master, Inc. of Las Vegas, Nev. That system includes: a) a physical gaming table; b) player monitors at each player position; c) a playing card reading and delivery system (e.g., commercially available shufflers and playing card delivery shoes with reading capability as sold under the Trade names of One2Six™ shuffler, Ace™ shuffler, I-DEAL™ shuffler, I-SHOE™ delivery shoe, etc.); d) a processor receiving information (numbers of cards, rank of cards, suits of cards, etc.) from the card reading and delivery systems; e) communication connectivity (hardwired or wireless) between necessary combinations of the card reading/delivery systems and the processor, the processor and the individual player monitors, and/or the card reading/delivery systems and the video monitors; and f) software in the processor that defines predetermined advantage for distributions of playing cards into multiple hands, game rules, hand history, and the like. In order to prevent a bet pattern exceeding the number of possible hands in a “live” shoe, a card count will be tracked and the remaining cards will be continually divided by six (the maximum number of cards for a hand).

With regard to software f), it is understood in the practice of the present technology that this is not complex software that reads individual player hand cards and determines advantageous card distributions for a first time by extensive calculations. Rather, the entire range of possibilities of hands (e.g., all possible five card sets dealt to players in poker-style games) is known in poker style games.

A preferable card handling device for administering a video reel-type-style game is a hand-forming shuffler with integrated card recognition technology, from which playing cards are supplied, with a least a rank/count (and preferable also suit) of individual packs of cards are known before the cards are removed and delivered to player positions and/or the banker position. The card delivery system is in communication with the controller by wired or wireless communication methods. Communication between the various system components is not limited to electronic or electrical signals, but may include optical signals, audio signals, magnetic transmission or the like.

The individual player position processors (not shown) are preferable graphics processors and not full content CPUs as a cost saving, space saving, and efficiency benefit. With the reduced capacity in the processor as compared to a CPU, there is actually reduced likelihood of tampering and fraudulent input.

A video gaming machine of the present invention may include a main cabinet, which generally surrounds the machine interior and is viewable by users. The main cabinet includes a main door on the front of the machine, which opens to provide access to the interior of the machine. Attached to the main door are player-input switches or buttons, a coin acceptor, and a bill validator, a coin tray, and a display area including a mechanical gaming system (or less preferably a separate electronic game). There may be an overlay of touchscreen functionality on the separate electronic game or some of the buttons may be functional on the separate mechanical gaming system. That separate mechanical gaming system may be in a relatively vertical viewing position as shown, or in a more horizontal (table like) display unit. Viewable through the main door is a video display monitor and an information panel. The display monitor will typically be a cathode ray tube, high resolution flat-panel LCD, LED, plasma screen or other conventional electronically controlled video monitor. The information panel may be a back-lit, silk screened glass panel with lettering to indicate general game information including, for example, a game denomination (e.g. $0.25 or $1). The bill validator, player-input switches, video display monitor, and information panel are devices used to play a game on the game machine. The devices are controlled by circuitry (e.g., the master gaming controller) housed inside the main cabinet of the machine.

Many different types of games, including mechanical slot games, video slot games, video poker, video black jack, video pachinko and lottery, may be provided with gaming machines of this invention. In particular, the gaming machine may be operable to provide a play of many different instances of games of chance. The instances may be differentiated according to themes, sounds, graphics, type of game (e.g., slot game vs. card game), denomination, number of paylines, maximum jackpot, progressive or non-progressive, bonus games, etc. The gaming machine may be operable to allow a player to select a game of chance to play from a plurality of instances available on the gaming machine. For example, the gaming machine may provide a menu with a list of the instances of games that are available for play on the gaming machine and a player may be able to select from the list a first instance of a game of chance that they wish to play.

The various instances of games available for play on the gaming machine may be stored as game software on a mass storage device in the gaming machine or may be generated on a remote gaming device but then displayed on the gaming machine. The gaming machine 2 may executed game software, such as but not limited to video streaming software that allows the game to be displayed on the gaming machine. When an instance is stored on the gaming machine, it may be loaded from the mass storage device into a RAM for execution. In some cases, after a selection of an instance, the game software that allows the selected instance to be generated may be downloaded from a remote gaming device, such as another gaming machine.

The typical gaming machine includes a top box, which sits on top of the main cabinet. The top box houses a number of devices, which may be used to add features to a game being played on the gaming machine, including speakers, a ticket printer which prints bar-coded tickets, a key pad for entering player tracking information, a florescent display for displaying player tracking information, a card reader for entering a magnetic striped card containing player tracking information, and a video display screen. The ticket printer may be used to print tickets for a cashless ticketing system. Further, the top box may house different or additional devices than discussed. For example, the top box may contain a bonus wheel or a back-lit silk-screened panel which may be used to add bonus features to the game being played on the gaming machine. As another example, the top box may contain a display for a progressive jackpot offered on the gaming machine. During a game, these devices are controlled and powered, in part, by circuitry (e.g. a master gaming controller) housed within the main cabinet of the machine.

Understand that gaming machine 2 is but one example from a wide range of gaming machine designs on which the present invention may be implemented. For example, not all suitable gaming machines have top boxes or player tracking features. Further, some gaming machines have only a single game display—mechanical or video, while others are designed for bar tables and have displays that face upwards. As another example, a game may be generated in on a host computer and may be displayed on a remote terminal or a remote gaming device. The remote gaming device may be connected to the host computer via a network of some type such as a local area network, a wide area network, an intranet or the Internet. The remote gaming device may be a portable gaming device such as but not limited to a cell phone, a personal digital assistant, and a wireless game player. Images rendered from 3-D gaming environments may be displayed on portable gaming devices that are used to play a game of chance. Further a gaming machine or server may include gaming logic for commanding a remote gaming device to render an image from a virtual camera in a 3-D gaming environments stored on the remote gaming device and to display the rendered image on a display located on the remote gaming device. Thus, those of skill in the art will understand that the present invention, as described below, can be deployed on most any gaming machine now available or hereafter developed.

Some preferred gaming machines are implemented with special features and/or additional circuitry that differentiates them from general-purpose computers (e.g., desktop PC's and laptops). Gaming machines are highly regulated to ensure fairness and, in many cases, gaming machines are operable to dispense monetary awards of multiple millions of dollars. Therefore, to satisfy security and regulatory requirements in a gaming environment, hardware and software architectures may be implemented in gaming machines that differ significantly from those of general-purpose computers. A description of gaming machines relative to general-purpose computing machines and some examples of the additional (or different) components and features found in gaming machines are described below.

At first glance, one might think that adapting PC technologies to the gaming industry would be a simple proposition because both PCs and gaming machines employ microprocessors that control a variety of devices. However, because of such reasons as 1) the regulatory requirements that are placed upon gaming machines, 2) the harsh environment in which gaming machines operate, 3) security requirements and 4) fault tolerance requirements, adapting PC technologies to a gaming machine can be quite difficult. Further, techniques and methods for solving a problem in the PC industry, such as device compatibility and connectivity issues, might not be adequate in the gaming environment. For instance, a fault or a weakness tolerated in a PC, such as security holes in software or frequent crashes, may not be tolerated in a gaming machine because in a gaming machine these faults can lead to a direct loss of funds from the gaming machine, such as stolen cash or loss of revenue when the gaming machine is not operating properly.

For the purposes of illustration, a few differences between PC systems and gaming systems will be described. A first difference between gaming machines and common PC based computers systems is that gaming machines are designed to be state-based systems. In a state-based system, the system stores and maintains its current state in a non-volatile memory, such that, in the event of a power failure or other malfunction the gaming machine will return to its current state when the power is restored. For instance, if a player was shown an award for a game of chance and, before the award could be provided to the player the power failed, the gaming machine, upon the restoration of power, would return to the state where the award is indicated. As anyone who has used a PC, knows, PCs are not state machines and a majority of data is usually lost when a malfunction occurs. This requirement affects the software and hardware design on a gaming machine.

A second important difference between gaming machines and common PC based computer systems is that for regulation purposes, the software on the gaming machine used to generate the game of chance and operate the gaming machine has been designed to be static and monolithic to prevent cheating by the operator of gaming machine. For instance, one solution that has been employed in the gaming industry to prevent cheating and satisfy regulatory requirements has been to manufacture a gaming machine that can use a proprietary processor running instructions to generate the game of chance from an EPROM or other form of non-volatile memory. The coding instructions on the EPROM are static (non-changeable) and must be approved by a gaming regulators in a particular jurisdiction and installed in the presence of a person representing the gaming jurisdiction. Any changes to any part of the software required to generate the game of chance, such as adding a new device driver used by the master gaming controller to operate a device during generation of the game of chance can require a new EPROM to be burnt, approved by the gaming jurisdiction and reinstalled on the gaming machine in the presence of a gaming regulator. Regardless of whether the EPROM solution is used, to gain approval in most gaming jurisdictions, a gaming machine must demonstrate sufficient safeguards that prevent an operator or player of a gaming machine from manipulating hardware and software in a manner that gives them an unfair and some cases an illegal advantage. The gaming machine should have a means to determine if the code it will execute is valid. If the code is not valid, the gaming machine must have a means to prevent the code from being executed. The code validation requirements in the gaming industry affect both hardware and software designs on gaming machines.

A third important difference between gaming machines and common PC based computer systems is the number and kinds of peripheral devices used on a gaming machine are not as great as on PC based computer systems. Traditionally, in the gaming industry, gaming machines have been relatively simple in the sense that the number of peripheral devices and the number of functions the gaming machine has been limited. Further, in operation, the functionality of gaming machines was relatively constant once the gaming machine was deployed, i.e., new peripherals devices and new gaming software were infrequently added to the gaming machine. This differs from a PC where users will go out and buy different combinations of devices and software from different manufacturers and connect them to a PC to suit their needs depending on a desired application. Therefore, the types of devices connected to a PC may vary greatly from user to user depending in their individual requirements and may vary significantly over time.

Although the variety of devices available for a PC may be greater than on a gaming machine, gaming machines still have unique device requirements that differ from a PC, such as device security requirements not usually addressed by PCs. For instance, monetary devices, such as coin dispensers, bill validators and ticket printers and computing devices that are used to govern the input and output of cash to a gaming machine have security requirements that are not typically addressed in PCs. Therefore, many PC techniques and methods developed to facilitate device connectivity and device compatibility do not address the emphasis placed on security in the gaming industry.

To address some of the issues described above, a number of hardware/software components and architectures are utilized in gaming machines that are not typically found in general purpose computing devices, such as PCs. These hardware/software components and architectures, as described below in more detail, include but are not limited to watchdog timers, voltage monitoring systems, state-based software architecture and supporting hardware, specialized communication interfaces, security monitoring and trusted memory.

A watchdog timer is normally used in gaming machines to provide a software failure detection mechanism. In a normally operating system, the operating software periodically accesses control registers in the watchdog timer subsystem to “re-trigger” the watchdog. Should the operating software fail to access the control registers within a preset timeframe, the watchdog timer will timeout and generate a system reset. Typical watchdog timer circuits contain a loadable timeout counter register to allow the operating software to set the timeout interval within a certain range of time. A differentiating feature of the some preferred circuits is that the operating software cannot completely disable the function of the watchdog timer. In other words, the watchdog timer always functions from the time power is applied to the board.

Gaming computer platforms preferably use several power supply voltages to operate portions of the computer circuitry. These can be generated in a central power supply or locally on the computer board. If any of these voltages falls out of the tolerance limits of the circuitry they power, unpredictable operation of the computer may result. Though most modem general-purpose computers include voltage monitoring circuitry, these types of circuits only report voltage status to the operating software. Out of tolerance voltages can cause software malfunction, creating a potential uncontrolled condition in the gaming computer. Gaming machines typically have power supplies with tighter voltage margins than that required by the operating circuitry. In addition, the voltage monitoring circuitry implemented in gaming computers typically has two thresholds of control. The first threshold generates a software event that can be detected by the operating software and an error condition generated. This threshold is triggered when a power supply voltage falls out of the tolerance range of the power supply, but is still within the operating range of the circuitry. The second threshold is set when a power supply voltage falls out of the operating tolerance of the circuitry. In this case, the circuitry generates a reset, halting operation of the computer.

The standard method of operation for slot machine game software is to use a state machine. Different functions of the game (bet, play, result, points in the graphical presentation, etc.) may be defined as a state. When a game moves from one state to another, critical data regarding the game software is stored in a custom non-volatile memory subsystem. This is critical to ensure the player's wager and credits are preserved and to minimize potential disputes in the event of a malfunction on the gaming machine.

In general, the gaming machine does not advance from a first state to a second state until critical information that allows the first state to be reconstructed is stored. This feature allows the game to recover operation to the current state of play in the event of a malfunction, loss of power, etc. that occurred just prior to the malfunction. After the state of the gaming machine is restored during the play of a game of chance, game play may resume and the game may be completed in a manner that is no different than if the malfunction had not occurred. Typically, battery backed RAM devices are used to preserve this critical data although other types of non-volatile memory devices may be employed. These memory devices are not used in typical general-purpose computers.

As described in the preceding paragraph, when a malfunction occurs during a game of chance, the gaming machine may be restored to a state in the game of chance just prior to when the malfunction occurred. The restored state may include metering information and graphical information that was displayed on the gaming machine in the state prior to the malfunction. For example, when the malfunction occurs during the play of a card game after the cards have been dealt, the gaming machine may be restored with the cards that were previously displayed as part of the card game. As another example, a bonus game may be triggered during the play of a game of chance where a player is required to make a number of selections on a video display screen. When a malfunction has occurred after the player has made one or more selections, the gaming machine may be restored to a state that shows the graphical presentation at the just prior to the malfunction including an indication of selections that have already been made by the player. In general, the gaming machine may be restored to any state in a plurality of states that occur in the game of chance that occurs while the game of chance is played or to states that occur between the play of a game of chance.

Game history information regarding previous games played such as an amount wagered, the outcome of the game and so forth may also be stored in a non-volatile memory device. The information stored in the non-volatile memory may be detailed enough to reconstruct a portion of the graphical presentation that was previously presented on the gaming machine and the state of the gaming machine (e.g., credits) at the time the game of chance was played. The game history information may be utilized in the event of a dispute. For example, a player may decide that in a previous game of chance that they did not receive credit for an award that they believed they won. The game history information may be used to reconstruct the state of the gaming machine prior, during and/or after the disputed game to demonstrate whether the player was correct or not in their assertion.

Another feature of gaming machines, such as gaming computers, is that they often contain unique interfaces, including serial interfaces, to connect to specific subsystems internal and external to the slot machine. The serial devices may have electrical interface requirements that differ from the “standard” EIA 232 serial interfaces provided by general-purpose computers. These interfaces may include EIA 485, EIA 422, Fiber Optic Serial, optically coupled serial interfaces, current loop style serial interfaces, etc. In addition, to conserve serial interfaces internally in the slot machine, serial devices may be connected in a shared, daisy-chain fashion where multiple peripheral devices are connected to a single serial channel.

The serial interfaces may be used to transmit information using communication protocols that are unique to the gaming industry. For example, the Netplex™ system of IGT is a proprietary communication protocol used for serial communication between gaming devices. As another example, SAS is a communication protocol used to transmit information, such as metering information, from a gaming machine to a remote device. Often SAS is used in conjunction with a player tracking system.

Gaming machines may alternatively be treated as peripheral devices to a casino communication controller and connected in a shared daisy chain fashion to a single serial interface. In both cases, the peripheral devices are preferably assigned device addresses. If so, the serial controller circuitry must implement a method to generate or detect unique device addresses. General-purpose computer serial ports are not able to do this.

Security monitoring circuits detect intrusion into a gaming machine by monitoring security switches attached to access doors in the slot machine cabinet. Preferably, access violations result in suspension of game play and can trigger additional security operations to preserve the current state of game play. These circuits also function when power is off by use of a battery backup. In power-off operation, these circuits continue to monitor the access doors of the slot machine. When power is restored, the gaming machine can determine whether any security violations occurred while power was off, e.g., via software for reading status registers. This can trigger event log entries and further data authentication operations by the slot machine software.

Trusted memory devices are preferably included in a gaming machine computer to ensure the authenticity of the software that may be stored on less secure memory subsystems, such as mass storage devices. Trusted memory devices and controlling circuitry are typically designed to not allow modification of the code and data stored in the memory device while the memory device is installed in the slot machine. The code and data stored in these devices may include authentication algorithms, random number generators, authentication keys, operating system kernels, etc. The purpose of these trusted memory devices is to provide gaming regulatory authorities a root trusted authority within the computing environment of the slot machine that can be tracked and verified as original. This may be accomplished via removal of the trusted memory device from the slot machine computer and verification of the secure memory device contents is a separate third party verification device. Once the trusted memory to retract tickets (or currency) and printed and eject tickets or currency is verified as authentic, and based on the approval of the verification algorithms contained in the trusted device, the gaming machine is allowed to verify the authenticity of additional code and data that may be located in the gaming computer assembly, such as code and data stored on hard disk drives. A few details related to trusted memory devices that may be used in the present invention are described in U.S. Pat. No. 6,685,567 titled “Process Verification,” which is incorporated herein in its entirety and for all purposes.

Mass storage devices used in a general purpose computer typically allow code and data to be read from and written to the mass storage device. In a gaming machine environment, modification of the gaming code stored on a mass storage device is strictly controlled and would only be allowed under specific maintenance type events with electronic and physical enablers required. Though this level of security could be provided by software, gaming computers that include mass storage devices preferably include hardware level mass storage data protection circuitry that operates at the circuit level to monitor attempts to modify data on the mass storage device and will generate both software and hardware error triggers should a data modification be attempted without the proper electronic and physical enablers being present.

Returning to the example of FIG. 1, when a user wishes to play the gaming machine 2, he or she inserts cash through the coin acceptor or bill validator or ticket-in-ticket out reading and printing drive with a motor to rtr. Additionally, the bill validator may accept a printed ticket voucher which may be accepted by the bill validator as an indicia of credit when a cashless ticketing system is used. At the start of the game, the player may enter playing tracking information using the card reader, the keypad 22, and the florescent display 16. Further, other game preferences of the player playing the game may be read from a card inserted into the card reader. During the game, the player views game information using the video display. Other game and prize information may also be displayed in the video display screen located in the top box.

During the course of a game, a player may be required to make a number of decisions, which affect the outcome of the game. For example, a player may vary his or her wager on a particular game, select a prize for a particular game selected from a prize server, or make game decisions which affect the outcome of a particular game. The player may make these choices using the player-input switches, the video display screen or using some other device which enables a player to input information into the gaming machine. In some embodiments, the player may be able to access various game services such as concierge services and entertainment content services using the video display screen and one more input devices.

During certain game events, the typical gaming machine may display visual and auditory effects that can be perceived by the player. These effects add to the excitement of a game, which makes a player more likely to continue playing. Auditory effects include various sounds that are projected by the speakers. Visual effects include flashing lights, strobing lights or other patterns displayed from lights on the gaming machine or from lights within the separate mechanical (or electronic) separately, individually wagerable gaming system. After the player has completed a game, the player may receive game tokens from the coin tray or the ticket from the printer, which may be used for further games or to redeem a prize. Further, the player may receive a ticket for food, merchandise, or games from the printer.

Another gaming network that may be used to implement some aspects of the invention is depicted in FIG. 1A. Gaming establishment 1001 could be any sort of gaming establishment, such as a casino, a card room, an airport, a store, etc. In this example, gaming network 1077 includes more than one gaming establishment, all of which are networked to game server 1022. Here, gaming machine 1002, and the other gaming machines 1030, 1032, 1034, and 1036, include a main cabinet 1006 and a top box 1004. The main cabinet 1006 houses the main gaming elements and can also house peripheral systems, such as those that utilize dedicated gaming networks. The top box 1004 may also be used to house these peripheral systems.

The master gaming controller 1008 controls the game play on the gaming machine 1002 according to instructions and/or game data from game server 1022 or stored within gaming machine 1002 and receives or sends data to various input/output devices 1011 on the gaming machine 1002. In one embodiment, master gaming controller 1008 includes processor(s) and other apparatus of the gaming machines described above. The master gaming controller 1008 may also communicate with a display 1010.

A particular gaming entity may desire to provide network gaming services that provide some operational advantage. Thus, dedicated networks may connect gaming machines to host servers that track the performance of gaming machines under the control of the entity, such as for accounting management, electronic fund transfers (EFTs), cashless ticketing, such as EZPay™ marketing management, and data tracking, such as player tracking. Therefore, master gaming controller 1008 may also communicate with EFT system 1012, EZPay™ system, and player tracking system 1020. The systems of the gaming machine 1002 communicate the data onto the network 1022 via a communication board 1018.

It will be appreciated by those of skill in the art that embodiments of the present invention could be implemented on a network with more or fewer elements than are depicted in FIG. 1A. For example, player tracking system 1020 is not a necessary feature of some implementations of the present invention. However, player tracking programs may help to sustain a game player's interest in additional game play during a visit to a gaming establishment and may entice a player to visit a gaming establishment to partake in various gaming activities. Player tracking programs provide rewards to players that typically correspond to the player's level of patronage (e.g., to the player's playing frequency and/or total amount of game plays at a given casino). Player tracking rewards may be free meals, free lodging and/or free entertainment. Player tracking information may be combined with other information that is now readily obtainable by an SBG system.

Moreover, DCU 1024 and translator 1025 are not required for all gaming establishments 1001. However, due to the sensitive nature of much of the information on a gaming network (e.g., electronic fund transfers and player tracking data) the manufacturer of a host system usually employs a particular networking language having proprietary protocols. For instance, 10-20 different companies produce player tracking host systems where each host system may use different protocols. These proprietary protocols are usually considered highly confidential and not released publicly.

Further, gaming machines are made by many different manufacturers. The communication protocols on the gaming machine are typically hard-wired into the gaming machine and each gaming machine manufacturer may utilize a different proprietary communication protocol. A gaming machine manufacturer may also produce host systems, in which case their gaming machines are compatible with their own host systems. However, in a heterogeneous gaming environment, gaming machines from different manufacturers, each with its own communication protocol, may be connected to host systems from other manufacturers, each with another communication protocol. Therefore, communication compatibility issues regarding the protocols used by the gaming machines in the system and protocols used by the host systems must be considered.

A network device that links a gaming establishment with another gaming establishment and/or a central system will sometimes be referred to herein as a “site controller.” Here, site controller 1042 provides this function for gaming establishment 1001. Site controller 1042 is connected to a central system and/or other gaming establishments via one or more networks, which may be public or private networks. Among other things, site controller 1042 communicates with game server 1022 to obtain game data, such as ball drop data, bingo card data, etc.

In the present illustration, gaming machines 1002, 1030, 1032, 1034 and 1036 are connected to a dedicated gaming network 1022. In general, the DCU 1024 functions as an intermediary between the different gaming machines on the network 1022 and the site controller 1042. In general, the DCU 1024 receives data transmitted from the gaming machines and sends the data to the site controller 1042 over a transmission path 1026. In some instances, when the hardware interface used by the gaming machine is not compatible with site controller 1042, a translator 1025 may be used to convert serial data from the DCU 1024 to a format accepted by site controller 1042. The translator may provide this conversion service to a plurality of DCUs.

Further, in some dedicated gaming networks, the DCU 1024 can receive data transmitted from site controller 1042 for communication to the gaming machines on the gaming network. The received data may be, for example, communicated synchronously to the gaming machines on the gaming network.

Here, CVT 1052 provides cashless and cashout gaming services to the gaming machines in gaming establishment 1001. Broadly speaking, CVT 1052 authorizes and validates cashless gaming machine instruments (also referred to herein as “tickets” or “vouchers”), including but not limited to tickets for causing a gaming machine to display a game result and cash-out tickets. Moreover, CVT 1052 authorizes the exchange of a cashout ticket for cash. These processes will be described in detail below. In one example, when a player attempts to redeem a cash-out ticket for cash at cashout kiosk 1044, cash out kiosk 1044 reads validation data from the cashout ticket and transmits the validation data to CVT 1052 for validation. The tickets may be printed by gaming machines, by cashout kiosk 1044, by a stand-alone printer, by CVT 1052, etc. Some gaming establishments will not have a cashout kiosk 1044. Instead, a cashout ticket could be redeemed for cash by a cashier (e.g. of a convenience store), by a gaming machine or by a specially configured CVT.

FIG. 1B illustrates an example of a network device that may be configured for implementing some methods of the present invention. Network device 1160 includes a master central processing unit (CPU) 1162, interfaces 1168, and a bus 1167 (e.g., a PCI bus). Generally, interfaces 1168 include ports 1169 appropriate for communication with the appropriate media. In some embodiments, one or more of interfaces 1168 includes at least one independent processor and, in some instances, volatile RAM. The independent processors may be, for example, ASICs or any other appropriate processors. According to some such embodiments, these independent processors perform at least some of the functions of the logic described herein. In some embodiments, one or more of interfaces 1168 control such communications-intensive tasks as encryption, decryption, compression, decompression, packetization, media control and management. By providing separate processors for the communications-intensive tasks, interfaces 1168 allow the master microprocessor 1162 efficiently to perform other functions such as routing computations, network diagnostics, security functions, etc.

The interfaces 1168 are typically provided as interface cards (sometimes referred to as “linecards”). Generally, interfaces 1168 control the sending and receiving of data packets over the network and sometimes support other peripherals used with the network device 1160. Among the interfaces that may be provided are FC interfaces, Ethernet interfaces, frame relay interfaces, cable interfaces, DSL interfaces, token ring interfaces, and the like. In addition, various very high-speed interfaces may be provided, such as fast Ethernet interfaces, Gigabit Ethernet interfaces, ATM interfaces, HSSI interfaces, POS interfaces, FDDI interfaces, ASI interfaces, DHEI interfaces and the like.

When acting under the control of appropriate software or firmware, in some implementations of the invention CPU 1162 may be responsible for implementing specific functions associated with the functions of a desired network device. According to some embodiments, CPU 1162 accomplishes all these functions under the control of software including an operating system and any appropriate applications software.

CPU 1162 may include one or more processors 1163 such as a processor from the Motorola family of microprocessors or the MIPS family of microprocessors. In an alternative embodiment, processor 1163 is specially designed hardware for controlling the operations of network device 1160. In a specific embodiment, a memory 1161 (such as non-volatile RAM and/or ROM) also forms part of CPU 1162. However, there are many different ways in which memory could be coupled to the system. Memory block 1161 may be used for a variety of purposes such as, for example, caching and/or storing data, programming instructions, etc.

Regardless of network device's configuration, it may employ one or more memories or memory modules (such as, for example, memory block 1165) configured to store data, program instructions for the general-purpose network operations and/or other information relating to the functionality of the techniques described herein. The program instructions may control the operation of an operating system and/or one or more applications, for example.

Because such information and program instructions may be employed to implement the systems/methods described herein, the present invention also relates to machine-readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media; and hardware devices that are specially configured to store and perform program instructions, such as read-only memory devices (ROM) and random access memory (RAM). The invention may also be embodied in a carrier wave traveling over an appropriate medium such as airwaves, optical lines, electric lines, etc. Examples of program instructions include both machine code, such as produced by a compiler, and files containing higher-level code that may be executed by the computer using an interpreter.

Although the system shown in FIG. 1B illustrates one specific network device of the present invention, it is by no means the only network device architecture on which the present invention can be implemented. For example, an architecture having a single processor that handles communications as well as routing computations, etc. is often used. Further, other types of interfaces and media could also be used with the network device. The communication path between interfaces may be bus based (as shown in FIG. 1B) or switch fabric based (such as a cross-bar).

Additional formats for execution of the wagering events described herein include electronic gaming tables (usually for multiple players) and distal gaming, which can be described as a multi-player gaming system for operating a game involving a live dealer, at least one live player and at least one virtual reality player, the multi-player gaming system comprising: (a) a physical gaming table; (b) a plurality of physical gaming elements for playing the game; (c) a processor or processors; (d) a gaming platform to host the game for the at least one virtual reality player; (e) a player terminal communicably coupled to the gaming platform via a network; (f) at least one camera for conveying a view of the dealer and the physical objects via the network to the player terminal from a perspective of someone seated or standing at the gaming table; and (g) a display at the gaming table to receive and display inputs into the game from the virtual reality player;
wherein the method of further includes executing a side bet wagering event in addition to hosting a primary wagering event during a modified game of baccarat comprising:
providing a unique set of from a modified set of at least 6 standard decks of fifty-two playing board layouts, with at least one but fewer than all 9-value playing board layouts replaced by a board layout indicating only a value of 9 but not any single suit;
a player position committing credit on the primary wagering event;
a player position committing credits on the side bet wagering event;
upon the recognition of the entry of a wager at a player position on the wagering event on the modified game of baccarat, dealing exactly two random playing board layouts from the modified set to each of a player position and a banker position;
providing additional random playing board layouts from the modified set as needed according to the standard rules of baccarat, with the exception that:
   the occurrence of at least one replacement board layout in a final player hand or banking hand in any player hand or banker hand having a final hand count total of 9 triggers an award against a paytable based on an amount placed on the side bet wagering event.

This system may have the physical objects include a plurality of chips, and the system further comprises a chip tray and a chip tray camera configured to capture an image of the plurality of chips placed in the chip tray. The system may have wherein the physical objects include a plurality of board layouts, and the system further comprising a board layout scanner configured to allow the dealer to scan a physical board layout to be distributed to the at least one virtual player. The gaming platform may include: (a) at least one processor, (b) memory, (c) at least one program, wherein the at least one program is stored in the memory and configured to be executed by the at least one process, the at least one program comprising instructions for: scanning by the board layout scanner a physical board layout to be distributed to a virtual player to generate a digital board layout associated with the virtual player corresponding to the physical board layout; transmitting the digital board layout to a terminal device of the virtual player via a network; and receiving a user input from the terminal device via the network. The system may have the at least one program of the gaming platform further comprises instructions for: displaying digital board layouts at a board layout area of the virtual player on the tablet table based on the user input received from the terminal device via the network. The system may have the at least one program of the gaming platform further comprises instructions for: capturing by the at least one camera at least one chip placed in a chip area of a real player on the tablet table; determining a number and a value of the at least one chip; and displaying the value of the at least one chip in the chip area of a live player on the terminal device of the virtual user. The unique set comprises physical playing board layouts delivered from a physical board layout delivery device comprising a dealer shoe or a shuffling machine, especially a continuous shuffling machine. This is one method of avoiding exhaustion of the specialty playing board layouts. That is done so that richness of the specialty board layouts is maintained within a general probability range to avoid such extreme instances where a specialty board layout is impossible (as all were used in previous rounds of play, or a specialty board layout is assured because the next four board layouts must contain a specialty board layout.

The physical playing tiles or board layouts, when provided from a continuous shuffling machine, has exhausted playing board layouts returned to the continuous shuffler before 50 playing board layouts are exhausted from the unique set.

An alternative distal gaming events is a method executed for real time attendance of one or more users from the primary wagering event at a remote game site at a primary wagering event going on at a relocated game site where a game surface exists, the method comprising: arranging one or more cameras at the relocated game site for producing audio/video recordings of the relocated game site; providing an audio and video reproduction of the recordings of the relocated game site at the remote game site via one or more monitors; at a game table located at the game site, virtually reproducing the game surface from the relocated game site, the game table including a monitor whereon the real-time updated image of the game surface existing in said relocated game site is reproduced; detecting one or more interface devices via a proximity mechanism and allowing the one or more interface devices to interact with the game table; wherein one or more of said one or more interface devices comprises at least a programmable electronic device of a wireless type; and wherein each of said programmable electronic devices is programmed so as to allow the respective user to attend the game at said relocated game site while bets performed by the respective user will be reproduced onto the game table at said remote game site. In this method, steps may include detecting the one or more interface devices based upon a QR-code; adapting the monitor of the game table located at the remote game for reproducing the QR-Code of the room identifying the game table; and adapting each of the programmable electronic devices for associating the respective user to the relocated game site upon scanning and processing the QR-Code.

By making firstly reference to FIG. 1C, a schematization of a system according to the present invention is shown. In general terms, a system 1 for the real time attendance, from a remote game site 2, at a game going on at relocated game site 3, comprises means 4, 6 for the audio and video reproduction of recordings of the relocated game site 3, at said remote game site 2, and means 5 for virtually repeating, in said remote game site 2, a game surface 10 existing in said relocated game site 3. Furthermore, the system comprises one or more interface devices 20 apt to allow an interaction between a gamer and said game surface 10 existing in said relocated game site 3. In order to make clear the modes therewith one wants to promote the real time remote game, the complete cycle which is performed by the gamer in this context is described hereinafter.

The cycle starts when a gamer enters the room of the remote site (shown in FIG. 2A) and, after acquiring the information reported inside the room and after viewing the live game session, coming from the relocated site 3, projected on one or more monitors/tv sets 4 of the room itself, wishes to attend the game. To this purpose the system provides the use of one or more interface devices 20 which, by way of example, may comprise at least a programmable electronic device of wireless type, for example a smartphone, or a tablet, or the like. Each programmable electronic device comprises a display, and it is configured for reproducing on said display information related to the game surface 10 existing in the relocated game site 3.

Furthermore, advantageously, the programmable electronic device is programmed so as to allow the gamer to attend the game from said remote site 2. For example, by exploiting current smartphones (or tablets or the like), the gamer is allowed, following registration on a web platform, to download an Application for accessing the game on his/her own smartphone or tablet (hereinafter such Application will be referred to with the short-term App). At this point, the gamer may load the funds he/she wishes on his/her own game account and he/she is ready to attend the available games.

As previously mentioned, the means 4 for the audio and video reproduction comprises one or more cameras 6 arranged at the relocated game site 3 and/or one or more monitors/tv sets arranged at the remote game site 2. In this way, in order to improve the game experience of the gamer, the live broadcast of the game session really performed by a croupier operating at the relocated side 3, is made available on a big monitor/tv set, which the gamer may attend through his/her own game App available on his/her own mobile device (smartphone or tablet or the like). For example, in case of the roulette game, the gamer has available on his/her own mobile device an App reproducing chips and game table, therethrough he/she may perform bets by touching the table area of interest.

FIG. 2B shows, schematically, the main components of a remote game site 2 according to one embodiment. In particular, a cash station 100 is shown, which will be handled by an operator of the game site 2, usable for example by the gamers for the preliminary procedures of loading funds onto their own game account.

The cash station 100 provides a personal computer 101, thereto a scanner 102 and a printer 103 are advantageously connected for the administrative type requirements (registration of gamers, scanning of identity documents, etc.). The cash station 100 could further be equipped with a router 104 (preferably of wireless type) for accessing a local network. Furthermore, in order to improve the game experience of the gamer and to promote the socialization with other people present in the room, inside the same there are means for virtually repeating the game surface 10. Said means comprises a game table 5, also shown in FIG. 2B.

The game table is equipped with apparatuses for implementing the function thereof of repeating the game surface 10. In particular, the game table 5 comprises a horizontal, preferably high-definition monitor, whereon an image is reproduced, updated in real time, of the game surface 10, existing in the relocated game site 3, and a QR-Code of the room identifying the table. Thanks to the help of such means, each bet performed by the gamer through his/her own App is repeated even onto the horizontal monitor, which reproduces the game layout of the baccarat table. Said horizontal monitor has no interactive feature, but it reproduces exclusively what made individually by each gamer on his/her own mobile device. Furthermore, as it is still visible in FIG. 2B, the game table 5 in turn comprises apparatuses to be connected, preferably in wireless mode, to the local network and, by means of internet, to the relocated game site. To this purpose, a processor 200 may be provided, thereto an access point 201, for the connection to Internet, and a router 204, for the connection to the local network, are connected, for example by means of a switch 203.

Furthermore, an additional monitor 300, arranged in the room of the remote game site 2, may be connected to the processor 200, in case by means of an additional personal computer 202, for enjoying a live broadcast by the gamers and/or other present people. Other multimedia devices, such as for example loudspeaker baffles 301, may be connected to the monitor.

Advantageously, by means of the cash PC 101, positioned in the cash station, the operator is capable to handle the devices constituting the system. For example, he/she could turn off and/or re-start the table, turn-off or re-start the PC for the live broadcast, change the camera for displaying the live broadcast from the casino.

Referring to FIGS. 2B and 5B, an illustrative system for implementing a mobile app wagering event of the present technology may include a device 240a having a processor 216a with a memory, one or more input peripherals 514, and one or more output peripherals 212a. System 240a may also include a network connection 204, and one or more remote computers 209a.

Ana illustrative device 504 is a smartphone or a tablet computer, although any other consumer electronic device can be used. The processor can comprise a microprocessor such as an Atom or A4 device. The processor's operation is controlled, in part, by information stored in the memory, such as operating system software, application software (e.g., “apps”), data, etc. The memory may comprise flash memory, a hard drive, etc.

The input peripherals 514 may include a camera, buttons, contact switch, pressure switch and/or a microphone. The peripherals (or device 512 itself) may also comprise an interface system by which analog signals sampled by the camera/microphone are converted into digital data suitable for processing by the system. Other input peripherals can include a touch screen, keyboard, etc. The output peripherals 512 212a can include a display screen, speaker, etc. The network connection to the cloud 510 can be wired (e.g., Ethernet, etc.), wireless (WiFi, 4G, Bluetooth, etc.), or both.

In an exemplary operation, device 216a receives a set of digital content data, such as through a wireless interface, through the network connection to the cloud 510, or otherwise. The content data may be of any type, but video content is required at a minimum, and audio is exemplary of additional content.

The system 240a preferably processes the digital content data to generate corresponding identification data. This may be done, e.g., by applying a password, digital watermark decoding process, or a fingerprinting algorithm—desirably to data representing the sonic or visual information itself, rather than to so-called “out-of-band” data (e.g., file names, header data, etc.). The resulting identification data serves to distinguish the received content data from other data of the same type (e.g., other audio or other video components).

By reference to this identification data, the system determines corresponding software that should be invoked and even open access to an online account that can be accessed by the player/user on the device. One way to do this is by indexing a table, database, or other data structure with the identification data, to thereby obtain information identifying the appropriate software. An illustrative table is shown conceptually in FIG. 2A.

In some instances the data structure may return identification of a single software program. In that case, this software is launched—if available. (Availability does not require that the software be resident on the device. Cloud-based apps may be available.) If not available, the software may be downloaded (e.g., from an online repository, such as the iTunes store or an online wagering company), installed, and launched. (Or, the device can subscribe to a software-as-service cloud version of the app.) Involvement of the user in such action(s) can depend on the particular implementation: sometimes the user is asked for permission; in other implementations such actions proceed without disturbing the user.

Sometimes the data structure may identify several different software programs. The different programs may be specific to different platforms, in which case, device 12 may simply pick the program corresponding to that platform (e.g., Android G2, iPhone 4, etc.). Or, the data structure may identify several alternative wagering programs that can be used on a given platform. In this circumstance, the device may check to determine which—if any—is already installed and available. If such a program is found, it can be launched. If two such programs are found, the device may choose between them using an algorithm (e.g., most-recently-used; smallest memory footprint; etc.), or the device may prompt the user for a selection. If none of the alternative programs is available to the device, the device can select and download one—again using an algorithm, or based on input from the user. Once downloaded and installed, the application is launched.

Sometimes the data structure may identify different programs that serve different functions—all related to the content. One, for example, may be an app for discovery of hints or suggestions for moves within the game. Another may be an app for purchase of the content (e.g., pay for a hint, especially if the display provides a signal that a “better move” is available. Again, each different class of software may include several alternatives.

Note that the device may already have an installed application that is technically suited to work with the received content (e.g., to render an active video file, operate a preapproved or licensed gaming content, MPEG4 or an MP3 file). For certain types of operations, there may be dozens or more such programs that are technically suitable. However, the content may indicate that only a subset of this universe of possible software programs should be used.

Software in the device 240a may strictly enforce the content-identified software selection. Alternatively, the system may treat such software identification as a preference that the user can override. In some implementations the user may be offered an incentive to use the content-identified software. Or, conversely, the user may be assessed a fee, or other impediment, in order to use software other than that indicated by the content.

Sometimes the system may decline to render certain content on a device (e.g., because of lack of suitable app or hardware capability), but may invite the user to transfer the content to another user device that has the needed capability, and may implement such transfer.

Instead of absolutely declining to render the content, the system may render it in a limited fashion. For example, a video might be rendered as a series of still key frames (e.g., from scene transitions). Again, the system can transfer the content where it can be more properly enjoyed, or—if hardware considerations permit (e.g., screen display resolution is adequate)—needed software can be downloaded and used.

As shown in FIGS. 2A and 5 (which data structure may be resident in the memory of processor 216a, or in a remote computer system 209a), the indication of software may be based on one or more contextual factors—in addition to the content identification data. (Only two context factors are shown; more or less can of course be used.)

One formal definition of “context” is “any information that can be used to characterize the situation of an entity (a person, place or object that is considered relevant to the interaction between a user and an application, including the user and applications themselves.” Another is the allowable or active state of the gaming event, as either a social event or a legal on-line wagering event.

Context information can be of many sorts, including computing context (network connectivity, memory availability, processor type, CPU contention, etc.), user context (user profile, location, actions, preferences, nearby friends, social network(s) and situation, etc.), physical context (e.g., lighting, noise level, traffic, etc.), temporal context (time of day, day, month, season, etc.), history of the above, etc.

In the technology, information data rows may correspond to the same content (i.e., same content ID), but they indicate different software should be used—depending on whether the user's context is indoors or outdoors. (The software is indicated by a symbol hex identifier; the content is identified by multiple hex symbols. Identifiers of other forms, and longer or shorter in length, can of course be used.) Row 36 shows a software selection that includes two items of software—both of which are invoked. (One includes a further descriptor—an identifier of a gaming event video that is to be loaded by software “FF245.”) This software is indicated for a user in a daytime context, and for a user in the 20-25 age demographic.

Information displayed may include user location (zip code) and gender as contextual data. The software for this content/context is specified in the alternative (i.e., four identifiers “OR”d together, as contrasted with the “AND” in other rows). The same content ID can correspond to different codecs—depending on the device processor (Atom or A4).

(By point of comparison, consider the procedure by which codecs are presently chosen in an exemplary-only manner. Typically, the user isn't familiar with technical distinctions between competing codecs, and the artist has no say. Codec selection is thus made by neither party that is most vitally interested in the choice. Instead, default codecs come bundled with certain media rendering software (e.g., Windows Media Player). If the defaults are unable to handle certain content, the rendering software typically downloads a further codec—again with no input from the parties most concerned.)

It will be understood that the software indicated by the content can be a stand-alone app, or a software component—such as a codec, driver, etc. The software can render the content, or it can be a content companion—providing other information or functionality related to the content. In some implementations the “software” can comprise a URL, or other data/parameter that is provided to another software program or online service (e.g., a YouTube video identifier).

All such software identified in the table may be chosen by the proprietor (e.g., game designer, layout artist, content creator or copyright-holder) of the content with which it is associated. This affords the proprietor a measure of artistic control that is missing in most other digital content systems. (The proprietor's control in such matters should be given more deference than, say, that of a content distributor—such as Double Deal™ internet gaming, AOL or iTunes. Likewise, the proprietor's choice seems to merit more weight than that of the company providing word processing and spreadsheet software for the device.)

The popularity of content can lead associated software to become similarly popular, which is why the ambience of the present game may channel a feel like that of the popular baccarat games. This can induce other content proprietors to consider such software for use with their own content, since wide deployment of that software may facilitate consumer exposure to the other proprietor's content.

(The software may be changed over time, such as through the course of a games' release cycle. When a new symbol image becomes desirable (as by modifying the game to holiday-reflective content), the table-specified software may include an app intended to introduce the new symbols to the public. After the gaming format has become popular and the game has become better known, a different software selection may be indicated.)

Presently, game discovery and other content-related applications are commonly performed by application software. Operating system (OS) software provides a variety of useful services—some of which (e.g., I/O) are commonly used in content-related applications. However, commercial OS software has not previously provided any services specific to content processing or identification. In accordance with a further aspect of the present technology, operating system software is provided to perform one or more services specific to content processing or identification.

In one particular implementation, an OS application programming interface (API) takes content data as input (or a pointer to a location where the content data is stored), and returns fingerprint data corresponding thereto. Another OS service (either provided using the same API, or another) takes the same input, and returns watermark information decoded from the content data. (An input parameter to the API can specify which of plural fingerprint or watermark processes is to be applied. Alternatively, the service may apply several different watermark and/or fingerprint extraction processes to the input data, and return resultant information to the calling program. In the case of watermark extraction, the resultant information can be checked for apparent validity by reference to error correction data or the like.)

The same API, or another, can further process the extracted fingerprint/watermark data to obtain XML-based content metadata that is associated with the content (e.g., text giving the title of the game, the name of the provider or designer, the intellectual property holder, etc.). To do this it may consult a remote metadata registry, such as maintained by a distal third party.

Such a content-processing API can establish a message queue (e.g., a playing/wagering queue) to which results of the fingerprint/watermark extraction process (either literally, or the corresponding metadata) are published. One or more application programs can monitor (hook) the queue—listening for certain identifiers. One app may be to alert to sizes of wagers, length of time in which gaming is active, and other relevant gaming information. When such content is detected, the monitoring app—or another—can launch into activity—logging the event, acting to complement the media content, offering a buying opportunity, offering side bets, offering a progressive jackpot wager, etc. Alternatively, such functionality can be implemented apart from the operating system. One approach is with a subscription model, by which some apps publish capabilities (e.g., looking for a particular type of gaming content event). By these arrangements, loosely-coupled applications can cooperate to enable a similar ecosystem.

One application of the present technology is to monitor media to which a user is exposed—as a background process. That is, unlike song identification services such as Shazam, the user need not take any action to initiate a discovery operation to learn the identity of a particular game or related game, but may request on-line transfer to that related game. (Of course, the user—at some point—must turn on the device, and authorize this background functionality.) Instead, the device listens for a prolonged period—much longer than the 10-15 seconds of Shazam-like services, during the course of the user's day. As content is encountered, it is processed and recognized.

The recognition information is logged in the device, and is used to prime certain software to reflect exposure to such content—available the next time the user's attention turns to the device. In some implementations the device can prime software applications with information that is based, at least in part, on the content identification data. This priming may cause an associated app to show a thumbnail corresponding to a gaming video for a game identified as similar by the processor or the player, readying it for selection. Likewise, a 90 second sample video clip may be downloaded to the iPod music player app—available in a “Recent Encounters” folder. An email from the game designers might be added to the user's email InBox. Such data is resident locally (i.e., the user needn't direct its retrieval, e.g., from a web site), and the information is prominent to the user when the corresponding app is next used—thereby customizing these apps per the user's content experiences.

Social media applications can serve as platforms through which such information is presented, and shared. The present specification is directed towards multiple embodiments. The following disclosure is provided in order to enable a person having ordinary skill in the art to practice the invention. Language used in this specification should not be interpreted as a general disavowal of any one specific embodiment or used to limit the claims beyond the meaning of the terms used therein. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

For purposes of this application, a social network is an on-line community defined by a first set of data, organized into an account in a mobile application or a set of web pages, that are controlled by and defining the interests, profile, images, video, audio, or other information of a first user (collectively first user data), and a second set of data, organized into an account in a mobile application or a set of web pages, each controlled by and defining the interests, profile, images, video, audio, or other information of a second user (collectively second user data), where the first user can selectively grant to the second user access to the first user data and/or where the second user can selectively grant to the first user access to the second user data. It should be appreciated that the selective granting of data access can be applied by any number of first users by and among any number of second users. It should further be appreciated that when a first user grants to the second user access to the first user data, the first user is “connected” to the second user.

For purposes of this application, a mobile platform is an operating system programmed to execute on a mobile device, such as a phone or tablet computer, and connect with a remotely hosted e-commerce store for enabling a user to access a plurality of applications. The operating system defines a plurality of procedures, calls, methods, and other programmatic tools which, if adopted and integrated into the applications, permit the application to be purchased, downloaded, and used on the mobile device.

Both the mobile platform and social network are further defined in that they provide users with a single point of purchase functionality. Even though each may provide access to thousands of products and services, primarily software of different types from different vendors, they provide users with a single point of purchase functionality that is typically actuated by just inputting an identifier, unique to the user of the mobile platform or social network, which triggers a purchase process by authorizing the use of a stored set of billing processes, such as a bank withdrawal or credit card charging process. In this manner, a user of the mobile platform or social network need not engage with multiple different billing systems or re-input billing information every time the user wishes to purchase a software application from a new or different vendor. The mobile platform and social network provide a single purchase functionality that is integrated into the software for hosting the social network and its e-commerce store and integrated into the software for the mobile device operating system and its remotely hosted e-commerce store.

For purposes of this application, a mini-game is any digital content which can be interacted with by a first user to create a challenge for a plurality of second users. A mini-game differs from a conventional wagering game or gaming event in that it typically only includes a single level, a single life, and/or a single interaction screen and is designed to obtain an output which is reformatted as a challenge to a plurality of second users, without placing value at risk. The term mini-game may include abbreviated versions of conventional games such as question and answer games, chain games, fantasy games, arcade games, online video games, bingo, racing games, sporting games, football, baseball, tennis, bowling, ping pong, boxing, basketball, rowing, sailing, shooting, archery, judo, equestrian, gymnastics, wrestling, skiing, hockey, volleyball, cycling, fencing, golf, dominoes, baccarat, word games, crosswords, Scrabble, role play, casino games, roulette, craps, dice games, canasta, chess, checkers, simulation games, mah jong, any card games, including poker, all fives, blackjack, old maid, bridge, pai gow, rummy, 21, crazy eights, or cribbage, or any variations thereof.

It should be appreciated that all of the gaming systems described herein are operated by hosting servers, executing programmatic code, communicating in a wired or wireless manner with programmatic code on a client device being operated by a user, such as a mobile phone, tablet computer, personal computer, laptop or other computing device.

In an embodiment, the gaming site of the present specification provides users with an option to play one or more wagering events or gaming events or mini-games with one or more virtual opponents via the gaming website, via a social networking website such as Facebook® system, or via a mobile phone operating system, such as Apple® iOS or Google®, Android® systems and the like. In an embodiment, in order to play via a smart phone, a user is prompted to download and install a gaming application by first opening the gaming site on the phone and subsequently clicking on a link provided therein, especially security and verification information components and functions of the gaming events.

In an embodiment, a user may elect to play the game provided by the hosting gaming site via their social network sites such as Facebook® system. In an embodiment, a user may perform a search for the gaming application on his/her Facebook® system page and commence gameplay via opening the application, while still being on Facebook® system. This feature allows the user to play with one or more of his/her Facebook® system friends that happen to be online at that time by inviting such friends to play. The invite may be sent to the accounts or profile pages of friends. The user may also post updates on his/her homepage notifying everyone, or his/her friends, a time and date when the user would be playing the online game, thereby allowing other individuals to join the user's game at the notified times.

While accessing the gaming application via a social networking site, such as Facebook® system, a user is informed that the application would be accessing the user's basic information which may be made available by the networking site. The online gaming system of the present specification uses this basic information, such as the user's name and photo, as well as the user's friends list in order to enable the user to see and play with online friends. The gaming application also requests permission to send emails to the user by using the email (or texting or instant messaging) provided by the user to the networking site, in order to send the user alerts on the receipt of gifts, neighbor invitations, and occasionally information on new features, games and special offers, including virtual goods. The user may specify whether the application can send e-mails. Further the user may change the permission granted at any time. The gaming application also requests permission to post to the user's profile page (or ‘wall’) on the networking site for sharing gaming information and rewards with friends. The user may specify whether the application can make such postings. In addition, the user is informed that the gaming application may access the user's profile information provided on the networking site. For example, the gaming application may obtain the user's birth date from the profile information provided to ensure that the user receives age-appropriate content from the gaming application.

The user may also choose to play a mini-game (e.g., non-wagering or social app) selected from a set of games hosted by the gaming website via the website itself. In this case, the user is required to log-in to a social network from within the gaming site, in order to enable play, gift-sharing, etc. with his/her friends. In one embodiment, if a user does not have an account on any social networking site, the user is prompted to create one prior to commencing gameplay.

Architecture Overview—In one embodiment, the online gaming system of the present specification provides a user, which may be an individual, a company, a partnership, a charity, or any other legal entity, with an option of initiating certain mini-games that, when played, interconnected personal playstations, electronic gaming machines or personal devices 1002 in FIG. 1A, ease or expand the number of individuals that are part of the users' social network. That social network is visually described as a tree, but it may take any form that has some element of hierarchy embedded within it where an initiating user (the trunk, community owner, or social network owner) is at the base and other members are either directly connected to the initiating user or indirectly connected to the initiating user through other users.

In one embodiment, the tree trunk represents the player that initiates the game, also known as the first user or the initiating user. In one embodiment, branches, also known as a second (or third, fourth, etc.) user or one who was invited to play the game by the another user, represent all players that choose to progress in the game by receiving and engaging in a mini-game challenge from another user and distributing mini-game challenges to another set of users. In another embodiment, leaves represent all players that choose to remain in the game by receiving and engaging in a mini-game challenge from another user but not distributing any challenges from mini-games themselves. In one embodiment, branches and limbs are used interchangeably. In one embodiment, several trees, or several communities, form a forest.

Mini-games and wagering event gaming may comprise multiple different types of content, as described above, and, within each type of content, multiple different formats. A format may comprise of several types of media, including but not limited to text, audio, images, or video media. In one embodiment, the content is a question and answer game that is passed along among the “initiating player” and “subsequent players”. Thus, the content may comprise multiple different formats, including a multiple game content selector, multiple choice selections of virtual symbols (i.e. text, video and/or audio) or a series of images. An “initiating user” can select from many different types of content and corresponding formats through which their game is entered and for subsequent players to engage in. In addition, within each content type, there are several themes, which are genres or sub-genres. Different types of content, formats, symbol themes, and game themes are described below. While throughout this text, examples are provided with respect to “questions”, it should be noted that this is for illustrative and descriptive purposes only and that any content type of any format may be used with the present invention as described in the present specification.

An intercom-flowchart may assist the general flow between participants in the mini-game described in the present specification. A user (also referred to as an “initiating user”) requests to initiate a mini-game and creates a challenge for other users/players. The request may take the form of the user signing into the game, the user accessing the gaming site via their electronic device, and/or the user selecting a button or other indicator to start the game. For a first-time user, they may be routed to a sign-up screen. If the user is a return user that has already logged in, then they will be taken to the home screen. In response to the request, the system presents an initiating user with a first piece of content, in at least one of a plurality of formats, as described below, thereby starting the social network hierarchy.

In one embodiment, in step 106, the initiating user inputs their response to the first piece of content or first question, where the response generally relates to the initiating user. The first piece of content or first question is modified in accordance with that response, for subsequent users to answer. In one embodiment, and described in greater detail below, the response is format dependent. For example, the response may be a personal answer to a question, a preference, an opinion, a time score value or any other response appropriate to the format. For example, in a puzzle mini-game, the response may include something such as the “time to beat”. If the response is something in the nature of “time to beat” then a “correct” response to that content would be a better time value (i.e. a shorter time spent to beat the game challenge).

The present specification may provide to a first user (the initiating user) a plurality of mini-games which that user can use to create a social network hierarchy which permits that first user to connect with and/or communicate directly with, all individuals within that social network hierarchy. Further, it should be noted that this hierarchy can be through dozens, hundreds, thousands, and an infinite number of levels, all of which may be communicated to or with by the initiating user. There is no requirement that this hierarchy be linear, in fact, as represented by the example of a tree, it can contain several branches and limbs all stemming from the initiating user. When any player invites a subsequent player to become part of the social network hierarchy, the subsequent player has the choice of whether to opt-in. While a first player may personally know the initiating user, and responds to the content (and in this example, question) with the knowledge that he will be in that initiating user's network when he engages in the game, this may not be true for subsequent users such as the third player, fourth player, etc. That person may not know the initiating user and may not want to be part of their mini-game community. Thus, in one embodiment, an opt-in is provided. It should be noted herein that each mini-game and its participants form a “social network” or “community” and that these terms may be used interchangeably.

In step 110, the first player(s) is prompted to answer the modified first piece of content or question that is presented to them. If a first player(s) responds to the modified content (or answers the first question) correctly based upon the initiating user's personal response, the first player(s) is prompted to input their response to the original content (in one embodiment, the original first question), or a new piece of content (in one embodiment, a second question) which may be selected in the same manner as described above, and send that modified first question or modified new content (a second question) to one or more of his or her members (a second set of one or more receiving users, also referred to as second player(s)) to which he or she is connected on one or more social networking sites, so that the second player(s) can answer that question. The second set of one or more receiving users may be selected by the first player(s), may be randomly selected from the first player(s)'s list of friends or contacts, and/or may be selected from the first player(s)'s established followers or fans, as indicated within the gaming system. In a wagering format, individual players may agree to contribute to a pot or jackpot, and the pot is distributed among the players according to a standing on points, wins and the like. The distal processor/server may (where legal) take a commission from the pot for managing the gaming event.

Thus, the second player(s) receive(s) the content when the gaming site presents the first player's challenge, as described above, to be responded to by the second player(s). Alternatively, multiple pieces of additional content (or multiple second questions, in one embodiment) can be selected and sent out to multiple second players from, by, or on behalf of the first player(s). In step 116, the second player(s) is prompted to respond to the content presented to them. Content that is correctly responded to enables the second player responding to the content to forward that content to a second set of one or more receiving users (or third player(s)), in the same manner described above. The goal of the mini-game is to keep the community growing as long as possible, from the initiating user to nth player(s).

Am APP operating system 10 of the present disclosure may include an APP operating device and an APP output device. The APP operating system having the above-mentioned configuration may output APP data of at least one APP executed in the APP operating device through the APP output device. According to various embodiments of the present disclosure, during the process of outputting APP data of at least one APP executed in the APP operating device through the APP output device, the APP output device may output APP data of at least some of APPs being executed in the APP operating device.

For example, assuming that five APPs are being operated in the APP operating device, APP data for at least one of the five APPs may be output through the APP output device. The APP operating device may output at least one running APP on the top layer while operating the five APPs and may support operation of the corresponding APPs in an execution status according to a user input. The APP operating device may maintain at least one APP in an activation status through background processing.

According to various embodiments of the present disclosure, the execution status may include at least one of a status in which the APP can be controlled according to an input signal in the APP operating device 100 and a status in which the APP is output on the top layer. The activation status may be a status in which the APP is not output on the top layer of a screen, or the APP is not operated according to an input signal although having been loaded in a memory. Among the APPs in the activation status, the APP having a widget function may be changed from the activation status to an execution status according to setting information. According to various embodiments of the present disclosure, the APPs in the activation status may be changed to the execution status by a user designation. Hereinafter, a memory may be an area in which information is recorded by a controller or data stored in a storage unit is loaded. For example, the memory may be a Random Access Memory (RAM) area, and/or the like. Such a memory may serve as a buffer in some cases.

The APP operating device corresponds to a device that stores at least one APP in the storage unit, activates the corresponding APP according to a user request, and thereafter provides an execution status selectively or in response to the user request. The APP operating device may transmit, to the APP output device 200, APP data for at least one APP during the execution status and the activation status according to a connection of the APP output device or a user control after the connection of the APP operating device to the APP output device. If the APP data is updated by operation of the corresponding APP, then the APP operating device may transmit the updated APP data to the APP output device.

The APP operating device may control operation of a specific APP according to at least one of an input signal from the APP output device and an input signal from an input unit included in the APP operating device. During this process, when the updated APP data is generated, the APP operating device may transmit the corresponding APP data to the APP output device. According to various embodiments of the present disclosure, the APP data may include at least one of image data and text data which can be output on a device display unit of the APP output device. Various configurations of the APP operating device for supporting an APP operating function according to various embodiments of the present disclosure will be described below more specifically with reference to FIGS. 2B and 5.

The APP output device may be connected to the APP operating device through at least one of wired and wireless connection. The APP output device may receive APP data associated with at least one APP provided by the APP operating device and may output the received APP data to the device display unit. According to various embodiments of the present disclosure, during the process of the APP output device receiving APP data associated with at least one APP provided by the APP operating device and outputting the APP data to the device display unit, in a case in which the APP operating device provides a plurality of APP data, the APP output device may classify the APP data and control such that the APP data is output to the device display unit as an APP area. According to various embodiments of the present disclosure, the APP output device may include the device display unit having a larger display area than that of the APP operating device. The APP output device may output the plurality of APP areas in the corresponding display area without the APP areas overlapping each other. Alternatively, even if the APP areas partially overlap each other, the APP output device may provide a proper display space such that a user may easily operate the respective APPs.

Further, the APP output device may display an APP area larger than that displayed in the APP operating device for a specific APP. According to various embodiments of the present disclosure, the APP output device does not simply expand the APP area of the APP operating device. According to various embodiments of the present disclosure, the APP output device may provide an expanded area containing more data. For example, if the APP operating device has output a list containing ten items, the APP output device may output a list containing twenty items. During this process, the APP output device may also provide, for the twenty items, areas equal to or larger than those assigned to the respective items in the APP operating device.

Meanwhile, the APP output device may include a device input unit. The APP output device may transmit an input signal for a control of an APP operation, which is input through the device input unit, to the APP operating device. When receiving APP data updated by the transmitted input signal, the APP output device may update displaying of an APP area related to the corresponding updated APP data. Configurations of the above-described APP output device and functions thereof will be described below more specifically.

According to various embodiments of the present disclosure, while providing the above-described functions, the APP operating system may perform more diverse control for the APPs operated in the APP operating device through the APP output device. Further, the APP operating system transmits a user control using the APP output device to the APP operating device and allows the user control to be performed for the corresponding APP. Accordingly, even in the APP output device, the user may freely operate at least one APP installed in the APP operating device 100. Meanwhile, the APPs in the above description are various APPs provided by the APP operating device and may include various APPs such as an APP in an activation or execution status according to a user selection and an APP activated at a specific time point according to a user setting. For example, the above-described APPs may include at least one of a dial input APP for a telephone call, an audio file or video file reproducing APP, a file editing APP, a broadcast receiving APP, a gallery APP, a chatting APP, an alarm APP, a calculator APP, a phonebook APP, a schedule APP, a calendar APP, and/or the like.

In an example using an electronic gaming machine (EGM) there is of course a value-in-value out system. In operation of this example embodiment, the process may begin after the gaming system establishes a credit balance for a player (such as after an acceptor of the gaming system receives and validates physical currency or a physical ticket associated with a monetary value).

The gaming system receives a game-initiation input (such as an actuation of a physical deal button or a virtual deal button via a touch screen) and, in response, places a wager on and initiates a play of a wagering game associated with a paytable. The paytable is determined based on the type of game being played and the wager (or in other embodiments the wagering game's denomination).

Such game-initiation input can include, by way of non-limiting examples, coin deposit and recognition slots, credit card or debit card readers (swipe and smart chip insertion and near-field communication chip reading), ticket-in-ticket-out (TITO) technology with a motor drive for receiving and an internal printer for providing tickets with coded content on value and security for recordation in a central gaming server, currency validators and provider with a camera to inspect currency and a two-way motor drive to pull and expel currency, similar to what is done with TITO systems. A gaming system using the underlying generic concepts of the invention may include, for example: a payment acceptor (including value-in-value out systems); a processor; and a memory device comprising instructions that, when executed, cause the processor to at least be responsive to a physical item being received via the payment acceptor (and/or initiation through a button or touchscreen with communication link to a credit/debit system) modify a credit balance based on a monetary value associated with the received physical item; and initiate a play of a wagering game responsive to receipt of a game-initiation input.

The APP operating device may include a communication unit, an input unit, an audio processing unit, a display unit, a storage unit, and a controller. According to various embodiments of the present disclosure, the APP operating device may further include a connection interface. In addition, the APP operating device may also further include an image sensor for image collection according to a design method. Moreover, the APP operating device may also further include various sensors as an input device such as an acceleration sensor or a proximity sensor, a motion sensor such as a gyro sensor, an illumination sensor, and/or the like.

Meanwhile, the connection interface corresponds to an interface to which at least one APP output device can be connected. For example, a smart TV, a smart monitor or another electronic device (e.g., terminal) may be connected to the connection interface of the APP output device.

The APP output device, which will be described below, may include various input units such as a keyboard, a mouse, an electronic pen, a joy stick, a remote controller, and/or the like as a device input unit. Accordingly, the connection interface may not only output APP data related to at least one APP to the APP output device but may also transfer an input signal generated by the APP output device to the controller. In this case, the connection interface may perform both an output function of outputting APP data of the APP operating device to the APP output device, and an input function of transferring a user input signal collected by the APP output device to the controller.

The communication unit supports a communication function of the APP operating device. The communication unit supports formation of at least one communication channel for supporting APPs requiring communication among the above-described various APPs as well as a message service function, a webpage search function, a video call function, a voice call function, a data transmission/reception function, a cloud function, and/or the like of the APP operating device. The communication unit may include a mobile communication module in a case in which the APP operating device supports a mobile communication function. Further, the communication unit may include a broadcast receiving module in a case in which the APP operating device supports a broadcast receiving function. If the communication unit forms a specific communication channel and receives data through the corresponding communication channel, then the received data may be provided to the controller. The controller may provide the corresponding data to the corresponding APP to support an APP operation. According to various embodiments of the present disclosure, APP data provided for the corresponding APP operation may also be provided to the APP output device.

The input unit generates various input signals required for operation of the APP operating device. The input unit may be formed in the shape of a specific key such as a button key, a side key, a home key, and/or the like. While one APP is in an activation status, the input unit is operated as a configuration for generating an input signal for operation of the corresponding APP. If an input signal generated by a push of the input unit is transferred to the controller, then the controller may provide the corresponding input signal to a running APP.

Meanwhile, in a case in which the display unit is provided in the form of a touch screen supporting a touch function, the input unit may include the display unit 140. A touch event generated through the display unit is transferred to the controller 160, and the controller may apply the touch event to a running APP. If an APP operation is updated by an input signal generated through the input unit, then the controller may transfer APP data updated according to the update of the APP operation to the APP output device.

The audio processing unit processes various audio signals generated in a process of operating the APP operating device. For example, the audio processing unit may include a Speaker (SPK) to support an output of an audio signal generated or decoded in the APP operating device, and in addition or in the alternative, may include a Microphone (MIC) configured to collect audio signals so as to support a voice or video call function and a recording function.

Meanwhile, if the APP output device is connected to the connection interface, then the audio processing unit may output a guide sound or sound effect corresponding to (or otherwise indicating) the connection. If specific APP data is transmitted to the APP output device, the audio processing unit 130 may output a guide sound or effect sound corresponding to the transmission. The above-described function of outputting the guide sound may be omitted or otherwise configured according to a manufacturer design and/or a user selection or preferences.

The display unit outputs various functional screens required during operation of the APP operating device. For example, the display unit 140 may display a menu screen, a screen for operating a specific APP, a screen for operating a plurality of APPs, a full screen of a specific APP during operation of a plurality of APPs, and/or the like. According to various embodiments of the present disclosure, the display unit may output an APP operation screen activated according to a user selection. The APP operation screen may be output in a landscape mode or portrait mode on the display unit according to a setting of a user or a setting of the corresponding APP. The APP operation screen output on the display unit may output information updated by an input signal input from the input unit or the device input unit. The updated information as updated APP data may be transferred to the APP output device. The various screen interfaces as described above will be described below more specifically with reference to the accompanying drawings.

Meanwhile, the above-described display unit may include a touch panel and a display panel for support of an input function. Further, the display unit may include a pen touch panel for operation of an electronic pen. The touch panel may be a panel, such as a capacitive touch panel, a resistive touch panel, and/or the like capable of detecting a physical or electronical change by a user finger-touch. The touch panel is disposed on a front or rear surface of the display panel and provides, to the controller, position information by a user finger touch and gesture information according to a user finger movement. The display panel is an area in which screen elements are output. The display panel is mapped with the touch panel and outputs various screen elements. For example, the display panel may output an operation screen of a specific APP among a plurality of APPs being operated. The pen touch panel is disposed on a front or rear surface of the display panel, recognizes an electronic pen according to proximity of the electronic pen, and provides information according to a movement of the electronic pen to the controller. The touch pen panel may be provided in various forms according to characteristics of the electronic pen. For example, the pen touch panel may be formed of an electromagnetic induction type panel. The touch panel and the pen touch panel as described above may be used as the input unit of the APP operating device. Meanwhile, in a case in which the APP operating device is designed such that at least one of a finger touch function and a pen touch function is not included, the display unit may be implemented as a configuration in which at least one of the touch panel and the pen touch panel is not included.

The storage unit may store various application programs required for operation of the APP operating device and various APP data generated during the operation of the APP operating device. For example, the storage unit may store programs including an operating system required for the operation of the APP operating device. More particularly, the storage unit stores various APPs related to user functions, and provides the APPs to the controller in response to a user request such that a function of the corresponding APP may be operated. According to various embodiments of the present disclosure, the storage unit may include a plurality of APPs and may include an output support program as illustrated. Further, the storage unit may include at least one buffer storing APP data generated according to operation of the APPs. Meanwhile, in a case in which a predetermined area of the storage unit is not provided as a buffer, a separate buffer may be disposed in the controller.

According to various embodiments of the present disclosure, the plurality of APPs are application programs for supporting various functions installed in the APP operating device. The plurality of APPs may be provided in the form of an icon or a separate menu item to the display unit, or may be activated according to a user request or schedule information while being allocated to hot keys. For example, the plurality of APPs includes the afore-mentioned various APPs including a voice call APP, a video call APP, a cloud APP, a camera APP, a web connection APP, a game APP, and/or the like. Further, the plurality of APPs may also include a plurality of APPs for similar functions. For example, the plurality of APPs may include a plurality of browser APPs. Further, the plurality of APPs may include a plurality of APPs regarding the camera. In addition, the plurality of APPs may include a plurality of APPs for utilization of the APP output device. Accordingly, in a case in which the plurality of APPs are activated, the APP operating device 100 may support operation and processing for each of the APPs. More particularly, the APP operating device may apply an input signal to a specific APP and may transfer APP data updated according to the input signal to the APP output device. According to various embodiments of the present disclosure, the output support program is a program for allowing APP data corresponding to at least one APP operated in the APP operating device to be output through the APP output device. The output support program may include a routine for loading at least one APP having received a request for activation in a memory, for example, a RAM, a routine for executing a designated specific APP among the loaded APPs, loading an operation screen of the executed APP in a frame memory or a frame buffer, and outputting the operation screen of the executed APP to the display unit, and/or the like. The frame memory or the frame buffer is a storage area allocated to the display unit and may be differentiated from a memory provided for the storage unit and the controller.

According to various embodiments of the present disclosure, the output support program may include a routine for determining a connection of the APP output device, a routine for transmitting APP data of at least some of APPs activated according to a setting or automatically to the connected APP output device, and/or the like. The output support program may include a routine for receiving an input signal for operating a specific APP from the APP output device, a routine for applying the received input signal to the operation of the corresponding APP, a routine for transmitting APP data updated according to the applying of the input signal to the APP output device, and/or the like.

According to various embodiments of the present disclosure, the output support program may include a routine for receiving an input signal from the input unit or the display unit having an input function, a routine for applying the received input signal to an APP displayed on the top layer or a specific running APP among the APPs, a routine for updating an operation screen of the corresponding APP, a routine for outputting the updated APP data to the APP output device, and/or the like. The output support program may include a routine for receiving an input signal generated according to a setting, a routine for determining an APP to which the corresponding input signal will be applied, a routine for applying the corresponding input signal to the corresponding APP, a routine for transmitting APP data updated according to the applying of the input signal to the APP output device, and/or the like. The output support program may include a routine for applying an input signal generated by the APP operating device to a running APP in the APP operating device, a routine for applying an input signal received from the APP output device to an APP outputting APP data to the APP output device, a routine for transmitting the corresponding APP data to which the input signal of the APP output device has been applied to the APP output device independently of the APP operation of the APP operating device, and/or the like.

According to various embodiments of the present disclosure, the output support program may include a routine for providing APP data to each of a plurality of APP output devices or a routine for distributing the APP data to the plurality of APP output devices, a routine for providing APP data according to a landscape or portrait mode for each of APPs to the APP output device, a routine for providing, to the APP output device, APP data for which a display mode of the corresponding APP is changed according to a signal, received from the APP output device, for requesting a change of a landscape or portrait mode, and/or the like. The output support program may include a routine for adjusting an APP area, which will be displayed according to an APP operation, in response to a request of the APP output device, a routine for adjusting a display buffer of the corresponding APP according to the change of the APP area, a routine for adjusting data allocation according to the adjustment of the display buffer, and/or the like.

The connection interface is a configuration for a connection with an APP output device which can be connected to the APP operating device. The connection interface may support both a wired manner and a wireless manner. Accordingly, the connection interface may include a wired serial connection interface such as a Universal Serial Bus (USB) interface, a Universal Asynchronous Receiver/Transmitter (UART) interface, and/or the like. Further, the connection interface may include a wireless connection interface such as, for example, a Bluetooth connection interface, a Zigbee connection interface, a Ultra WideBand (UWB) connection interface, a Radio Frequency IDentification (RFID) connection interface, an infrared ray connection interface, a Wireless Application Protocol (WAP) connection interface, a Near Field Communication (NFC) connection interface, and/or the like. Namely, the connection interface may include various types of communication connection interfaces that can be connected with the APP operating device. The connection interface may include a plurality of ports and a plurality of wireless communication modules for a connection with a plurality of APP output devices as well as a single APP output device.

The controller supports processing of various signals and data related to operation of the APP operating device. Namely, if the controller receives a request for activation of a specific APP, then the controller performs operation of the specific APP and supports an output of an APP operation screen on the display unit. According to various embodiments of the present disclosure, during the process of the controller performing an operation of the specific APP and supporting an output of the APP operation screen on the display unit, according to setting information or a user request, the controller may support an adjustment of a size, the number, a display direction, an update of an APP area to be displayed, and/or the like according to the operation of the specific APP and may support a control of the corresponding APP according to an input signal. According to various embodiments of the present disclosure, the controller may include configurations.

According to various embodiments of the present disclosure, the APP operating unit may switch a specific APP from an activation status to an execution status by setting information, and may control APP operation according to the corresponding information. According to various embodiments of the present disclosure, the APP operating unit may not execute the specific APP in the activation status, and may provide, through an interrupt signal form, that an event related to the corresponding APP has been generated.

Meanwhile, if the APP operating unit receives a request for execution of a specific APP from the input device including at least one of the input unit and the display unit supporting the input function, the APP operating unit may support the execution of the corresponding APP.

According to various embodiments of the present disclosure, if the APP is in an inactivation status, then the APP operating unit may load the APP in a memory and execute the APP. If the APP is in an activation status, the APP operating unit may switch the APP from the activation status to an execution status and may support an output of APP data according to the operation of the corresponding APP on the display unit.

Further, if the APP operating unit receives an input signal for operating the specific APP from the input device or the APP output device, then the APP operating unit may control application of the corresponding input signal to the corresponding APP. According to various embodiments of the present disclosure, the APP operating unit may control application of the input signal generated by the input device of the APP operating device to the APP running as a default. The APP operating unit may control the input signal received from the APP output device to be applied to an APP designated by the corresponding input signal. According to various embodiments of the present disclosure, the APP operating unit may control the input signal received from the APP output device to be processed through background processing. Further, the APP operating unit may change a status of the APP designated by the input signal received from the APP output device to an execution status, output the corresponding APP data to the display unit, and support application of the input signal.

According to various embodiments of the present disclosure, if the APP operating unit receives an event for a landscape or portrait mode of the APP operating device, then the APP operating unit may apply the event to an execution screen. According to various embodiments of the present disclosure, if a landscape mode or portrait mode is designated as a default mode for a specific APP, then the APP operating unit may support maintenance of the corresponding landscape mode or portrait mode irrespective of a horizontal or vertical status (e.g., the orientation) of the APP operating device. Further, while a specific APP is being operated in a landscape or portrait mode, if another APP enters an execution status and the running APP is changed to an activation status, the APP operating unit may maintain the landscape or portrait mode shortly before the operation of the corresponding APP.

Accordingly, APP data of the specific APP may be stored in a memory while being maintained in the status in which the specific APP has been executed, for example, in the landscape or portrait mode. Meanwhile, the APP operating unit may change a screen of the specific APP from a landscape mode to a portrait mode or from a portrait mode to a landscape mode in response to a request of the APP output device. According to various embodiments of the present disclosure, the four screens of APPs being performed through background processing as well as the screen of the specific APP being output on the display unit, the APP operating unit may control a change of a landscape or portrait mode of the APP differentiated by the input signal from the APP output device.

The APP operating unit may also apply both the input signal from the input device and the input signal from the APP output device to a single APP. The APP operating unit may sequentially apply the respective input signals to the single APP according to a reception time of the input signals to be transferred.

The APP operating unit may set an output size of a specific APP to be larger than an area of the display unit of the APP operating device. For example, assuming that the display unit has a full size of 10×10, the APP operating unit may output a screen having a size of 10×10 according to the received input signal and may change a size of the running APP to a size of 20×20.

According to various embodiments of the present disclosure, the APP operating unit may allocate additional data to the expanded area. The APP operating unit may perform data processing for an area which is not currently displayed on the display unit through background processing to thereby support a data update of the corresponding area. Consequently, the APP operating unit may set the APP screen to have a larger size in the memory, and may perform data writing suitable for the set size of the APP screen. Meanwhile, the APP operating unit may support an output of only the area corresponding to the size of the display unit and may support data updating for the remaining area. The APP operating unit may control a memory allocation size for an adjustment of the above-described APP screen. Namely, the APP operating unit may expand and allocate the memory area to write data having a size larger than the display unit.

The APP data collecting unit collects APP data generated while the APP operating unit operates at least one APP. For example, if APP data is recorded in the memory by APPs activated by the APP operating unit, then the APP data collecting unit may collect the corresponding APP data. According to various embodiments of the present disclosure, the APP data collecting unit may collect the whole APP data of all APPs recorded in the memory. Alternatively, the APP data collecting unit may also collect only some of the APP data of all the APPs. For example, if five APPs are in an activation status, then the APP data collecting unit may collect the respective five APP data. Alternatively, the APP data collecting unit may collect only some APP data selected to be transmitted to the APP output device among the five APP data.

Meanwhile, if the APP data is updated after the APP data collecting unit collects the respective APP data, then the APP data collecting unit may collect only the updated APP. The respective APP data collected by the APP data collecting unit may be transferred to the APP output device through the connection interface. According to various embodiments of the present disclosure, the APP data collecting unit may provide, to the APP output device, the APP data including index information or identification information to be differentiated by the APP output device. Further, the buffer operating unit may allocate separate distinguishable buffers so as to provide the respective APP data to the APP output device. The APP data collecting unit may record the corresponding APP data in the respective buffers to provide the APP data to the APP output device. For example, the buffer operating unit may allocate buffers to five APPs, respectively, and the APP data collecting unit may record APP data of the APPs in the respective buffers. According to various embodiments of the present disclosure, during the process of the buffer operating unit allocating buffers for the respective APP data, the buffer operating unit may allocate a new buffer when a new APP is activated, and may withdraw the allocated buffer when the APP in an activation status is terminated.

The APP data transmitting unit may transmit the APP data collected by the APP data collecting unit to the APP output device. Further, the APP data transmitting unit may transmit the updated APP data collected by the APP data collecting unit to the APP output device. According to various embodiments of the present disclosure, the APP data transmitting unit may control formation of a communication channel with the APP output device connected to the connection interface. According to various embodiments of the present disclosure, the APP data transmitting unit may control formation of at least one of a wired communication channel and a wireless communication channel. The APP data transmitting unit may use at least one communication channel for transmission of the respective APP data. For example, the APP data transmitting unit may create at least one of various communication channels including a WiFi communication channel, a USB communication channel, a UART communication channel, a BT communication channel, and/or the like between the APP data transmitting unit and the APP output device. The APP data transmitting unit may transmit some of the APP data to the APP output device through a USB communication channel and may transmit other APP data to the APP output device through a BT communication channel. Further, the APP data transmitting unit may transmit the remaining APP data to the APP output device through a WiFi communication channel, a UART communication channel, and/or the like. The technology of U.S. Pat. No. 9,311,167 (Kim) enabling such APPS is also incorporated herein by reference.

The present technology may also be executed as a method or a system for executing that method of operating an Application (APP) on a hand-held telecommunication device with a processor, player input controls and video display therein. A method of performing a gaming event on virtual letter symbols displayed on a display screen, wherein the gaming event.

The present disclosure has been so far described with reference to exemplary embodiments thereof. It is to be meant that each one of the technical solutions implemented in the disclosed embodiments, herein described by way of example, may advantageously be combined, in different way with respect to what described, with the other ones, to create additional embodiments, belonging to the same inventive core and however all within the protective scope of the claims.

Other variations can be added to the underlying execution of the wagering event. These and all other citations in this patent application are incorporated being by reference in their entirety.

What is claimed:

1. A method of executing a two-player position competitive game of GO with improved rate of play and reduction in required skill by players comprising:
a) providing a game board with a grid having between 4×4 and 6×6 squares for alternative placement of visually different stones in squares to capture an opposing player's stones or to control enclosed squares;
b) placing stones for each of the two players, with at least three stones being placed by random placement or from a template for each player, with no player beginning the method with two stones more than another player;
c) each player being allotted a specific number of additional stones for alternative placement in open squares on the game board, but with insufficient numbers of stone to fill the game board;
d) each player exhausting respective allotted stones;
e) after the two players have exhausted all respective allotted stones, determining a total absolute number value of how many stones have been captured by each player and how many spaces are controlled by each player's stones, with each player's total being compared either to the other player's total or against a paytable to determine a winning or losing outcome for the board game.

2. The method of claim 1 wherein a virtual game of GO is executed on an electronic gaming machine including a processor, a video display with a touchscreen, and in communication with the processor a value-in-value-out system selected from the group consisting of a currency receiver having a motor drive and a reader, a ticket-in-ticket out acceptor/printer having a motor drive to receive printed tickets and deliver tickets printed in the electronic gaming machine, and a near-field communication sensor, the processor in communication with the video display to display credits available for wagering and amount of credits wagered and/or won at the conclusion of each virtual board game displayed as a virtual board game.

3. The method of claim 2 wherein the grid is a virtual grid of from 4×4 to 6×6 squares, displayed on the display screen, and the processor provides a random combination of the two-player's stones as virtual stones on the video screen and assigns a fixed number of allotted virtual stones to a first player at player controls and to the processor as a virtual player in competition with the first player at the player controls, the first player placing one virtual stone at a time by contacting the touchscreen on open squares to place a single virtual stone, and the processor placing virtual stones in open spaces on the virtual grid.

4. The method of claim 3 wherein the first player controls enters a wager stored in a memory in the processor to initiate the game.

5. The method of claim 4 wherein points attained by the player at the player controls are compared against a paytable to determine a winning amount to be credited on the processor.

6. The method of claim 2 wherein the grid is a virtual grid of from 4×4 to 6×6 squares, displayed on the display screen, and the processor provides a template of a predetermined distribution of the two-player's stones as virtual stones on the video screen and assigns a fixed number of allotted stones to a player at player controls and to the processor as a virtual player in competition with the player at the player controls, the player at the player controls placing one virtual stone at a time by contacting the touchscreen on open squares to place, and the processor placing virtual stones in open spaces on the virtual grid.

7. The method of claim 6 wherein the player at the player controls enters a wager stored in a memory in the processor to initiate the game.

8. The method of claim 7 wherein points attained by the player at the player controls are compared against a paytable to determine a winning amount to be credited on the processor.

10. A method of executing a wagering event on an electronic gaming machine including a processor, a video display with a touchscreen, and in communication with the processor a value-in-value-out system selected from the group consisting of a currency receiver having a motor drive and a reader and a ticket-in-ticket out acceptor/printer having a motor drive to receive printed tickets, the method comprising:
a) providing a virtual game board with a grid having between 4×4 and 6×6 virtual squares for a first player to execute alternative placement of visually different virtual stones in the virtual squares into the virtual grid by contacting the virtual squares through the touchscreen to capture an opposing player's virtual stones or to control enclosed virtual squares;
b) the processor placing virtual stones for both of the two players, with at least three stones being placed by the processor by random placement or from a template for each player, with the processor providing no player beginning the method with two virtual stones more than another player;
c) each player being allotted a specific number of additional virtual stones for alternative placement in open virtual squares on the virtual game board, but with insufficient numbers of virtual stones to fill the virtual game board;
d) each player exhausting respective allotted virtual stones;
e) after the two players have exhausted all respective allotted virtual stones, determining a total absolute number value of how many virtual stones have been captured by the first player and how many virtual spaces are controlled by the first player's virtual stones, with the first player's total being compared either to a paytable to determine a winning or losing outcome for the board game.

11. A method of performing a less than standard-sized GO gaming event on electronic display equipment displayed on a display screen, wherein the gaming event:
a) is effectuated by a plurality of programmatic instructions stored in a non-volatile memory, either remote or local to client devices and servers, and
b) is executed by processors at the client devices or servers after input by a player into a player input device in communication with the non-volatile memory,
said method comprising the steps of:
c) providing a gaming application downloaded onto a mobile device and for use on a mobile platform;
d) providing a database of virtual GO game boards with partial player pieces distribution and a specific limited number of additional actionable playing pieces playing cards;
e) enabling an initiating user with the downloaded gaming application to place value at risk on an outcome of a gaming wager ultimately determined by predefined outcomes of the virtual GO game board;
2.
f) providing a game board with a grid having between 4×4 and 6×6 squares for alternative placement of visually different stones in squares to capture an opposing player's stones or to control enclosed squares;
g) placing stones for each of the two players, with at least three stones being placed by random placement or from a template for each player, with no player beginning the method with two stones more than another player;
h) each player being allotted a specific number of additional stones for alternative placement in open squares on the game board, but with insufficient numbers of stone to fill the game board;
i) each player exhausting respective allotted stones;
j) after the two players have exhausted all respective allotted stones, determining a total absolute number value of how many stones have been captured by each player and how many spaces are controlled by each player's stones, with each player's total being compared either to the other player's total or against a paytable to determine a winning or losing outcome for the board game.

12. A method of operating an Application (APP) on a hand-held telecommunication device with a processor, player input controls and video display therein, the method comprising: connecting an APP operating device in the hand-held communication device through a wireless connection to an APP output device; transmitting programmatic gaming instructions of a gaming event APP from the APP operating device to the hand-held communication device to be stored in non-volatile memory, the hand-held communication device downloading the gaming APP for access by the processor,
wherein the gaming event:
a) is effectuated by a plurality of programmatic instructions stored in the non-volatile memory in communication with the processor, and
b) is executed by the processor in the hand-held device by player input through the player input device in communication with the non-volatile memory,
said method comprising the steps of:
c) the processor executing the downloaded gaming event APP downloaded;
d) the processor providing a database of a unique set of virtual symbols comprising partially filled frames of 4×4 to 6×6 GO game boards with an incomplete total final set of player pieces distributed thereon;
e) enabling an initiating user with the downloaded gaming application to initiate a game event ultimately determined by predefined outcomes of randomly distributed virtual playing card symbols distributed to a player position hand and a banker position hand;
f) a player position committing credit on the primary wagering event;
g) upon the recognition of the entry of a wager at a player position on the wagering event on the GO game board, providing the partially filled GO game board;
h) providing a game board with a grid having between 4×4 and 6×6 squares for alternative placement of visually different stones in squares to capture an opposing player's stones or to control enclosed squares;
i) placing stones for each of the two players, with at least three stones being placed by random placement or from a template for each player, with no player beginning the method with two stones more than another player;
j) each player being allotted a specific number of additional stones for alternative placement in open squares on the game board, but with insufficient numbers of stone to fill the game board;
k) each player exhausting respective allotted stones;
l) after the two players have exhausted all respective allotted stones, determining a total absolute number value of how many stones have been captured by each player and how many spaces are controlled by each player's stones, with each player's total being compared either to the other player's total or against a paytable to determine a winning or losing outcome for the board game.

13. The method of claim 11 wherein the grid is a virtual grid of from 4×4 to 6×6 squares, displayed on the display screen, and the processor provides a random combination of the two-player's stones as virtual stones on the video screen and assigns a fixed number of allotted virtual stones to a first player at player controls and to the processor as a virtual player in competition with the first player at the player controls, the first player placing one virtual stone at a time by contacting the touchscreen on open squares to place a single virtual stone, and the processor placing virtual stones in open spaces on the virtual grid.

14. The method of claim 13 wherein the first player controls enters a wager stored in a memory in the processor to initiate the game.

15. The method of claim 14 wherein points attained by the player at the player controls are compared against a paytable to determine a winning amount to be credited on the processor.

16. The method of claim 12 wherein the grid is a virtual grid of from 4×4 to 6×6 squares, displayed on the display screen, and the processor provides a random combination of the two-player's stones as virtual stones on the video screen and assigns a fixed number of allotted virtual stones to a first player at player controls and to the processor as a virtual player in competition with the first player at the player controls, the first player placing one virtual stone at a time by contacting the touchscreen on open squares to place a single virtual stone, and the processor placing virtual stones in open spaces on the virtual grid.

17. The method of claim 16 wherein the first player controls enters a wager stored in a memory in the processor to initiate the game.

18. The method of claim 17 wherein points attained by the player at the player controls are compared against a paytable to determine a winning amount to be credited on the processor.

19. The method of claim 3 wherein the processor as the virtual player receives from 0-4 stones.
